(19) United States
(12) Patent Application Publication
(10) Pub. No.: US 2014/0330832 A1
(43) Pub. Date: Nov. 6, 2014

(54) Universal Idea Capture and Value Creation Apparatuses, Methods and Systems

(71) Applicant: My Ideal World, Inc., New York, NY (US)

(72) Inventor: Martin Viau, New York, NY (US)

(73) Assignee: My Ideal World, Inc., New York, NY (US)

(21) Appl. No.: 14/269,931

(22) Filed: May 5, 2014

Related U.S. Application Data
(60) Provisional application No. 61/819,632, filed on May 5, 2013.

(51) Int. Cl. G06F 17/30

(52) U.S. Cl. CPC G06F 17/30312; G06F 17/30598; G06F 17/30958
USPC 707/740; 707/748

(57) ABSTRACT

The UNIVERSAL IDEA CAPTURE AND VALUE CREATION APPARATUSES, METHODS AND SYSTEMS (“UIC”) transform user idea input requests using UIC components into idea categorization and valuation inputs. In some implementations, the disclosure provides a processor-implemented method of transforming a user idea input request into an idea matching and trigger update message and processor implemented method of determining a corresponding match for need want structures.

This patent application is a non-provisional of and claims priority under 35 USC §119 to: U.S. provisional patent application Ser. No. 61/819,632 filed May 5, 2013, entitled “UNIVERSAL IDEA CAPTURE AND VALUE CREATION APPARATUSES, METHODS AND SYSTEMS,” attorney docket no. 319618-2001. The entire contents of the aforementioned application(s) are expressly incorporated by reference herein.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address the assembly of idea inputs into actionable idea groupings and synthesized idea outputs, and more particularly, include UNIVERSAL IDEA CAPTURE AND VALUE CREATION APPARATUSES, METHODS AND SYSTEMS.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Consumers may have ideas regarding improvements that can be made to businesses, products, government services, charities, and/or the like. Service and product providers strive to be attentive and responsive to consumers' mindsets including needs, interests and preferences employing these insights as guidelines to develop and improve new and existing products and services. Effective communication between thinkers and providers may lead to the design of better products and services and an increased customer satisfaction.

### BRIEF DESCRIPTION OF THE DRAWINGS

The accompanying appendices and/or drawings illustrate various non-limiting, example, innovative aspects in accordance with the present descriptions:

FIG. 1 shows an example block diagram illustrating aspects of the UIC, in one implementation of the UIC operation;

FIG. 2 shows an example data flow illustrating aspects of universal idea capture and valuation, in one implementation of the UIC operation;

FIG. 3 shows an example data flow illustrating aspects of idea Capture, idea subject review process and wish match, in one implementation of the UIC operation;

FIG. 4 shows an example logic flow illustrating aspects of processing idea input, e.g., PII Component 400, in one implementation of the UIC operation;

FIG. 5A-B shows an example logic flow illustrating aspects of processing idea capture, e.g., IC Component 500, in one implementation of the UIC operation;

FIG. 6 shows an example logic flow illustrating aspects of subject review process, e.g., ERP Component 600, in one implementation of the UIC operation;

FIG. 7A-C shows an example logic flow illustrating aspects of process idea review response, e.g., PIRR Component 700, in one implementation of the UIC operation;

FIG. 8A-B shows an example logic flow illustrating aspects of wish match component, e.g., WM Component 800, in one implementation of the UIC operation;

FIG. 9 shows an example data model including entities' relations, in one implementation of the UIC operation;

FIG. 10 shows an example of the taxonomy of a subject model and relations between UIC entities, in one implementation of the UIC operation;

FIG. 11 shows an example of ideas decomposition and insights production, in one implementation of the UIC operation;

FIG. 12 shows an example database schema, in one implementation of the UIC operation;

FIG. 13 shows an example user interface: universal idea input, in one implementation of the UIC operation;

FIG. 14 shows an example of thinkers graphical user interface screen shots, in one implementation of the UIC operation;

FIG. 15 shows an example of UIC associate graphical user interface for the registration of a new “want”, in one implementation of the UIC operation;

FIG. 16 shows an example UIC associate graphical user interface for the registration of a new subject/entity, in one implementation of the UIC operation;

FIG. 17 shows an example of insights consumption application screen shot, in one implementation of the UIC operation;

FIG. 18 shows an example of entity associates want processing dash board and example of notification subscription screen shot, in one implementation of the UIC operation;

FIG. 19 shows an example of notifications according to user selected parameter, in one implementation of the UIC operation; and

FIG. 20 shows a block diagram illustrating aspects of an exemplary embodiment of a UIC user interface controller, in one implementation of the UIC operation.

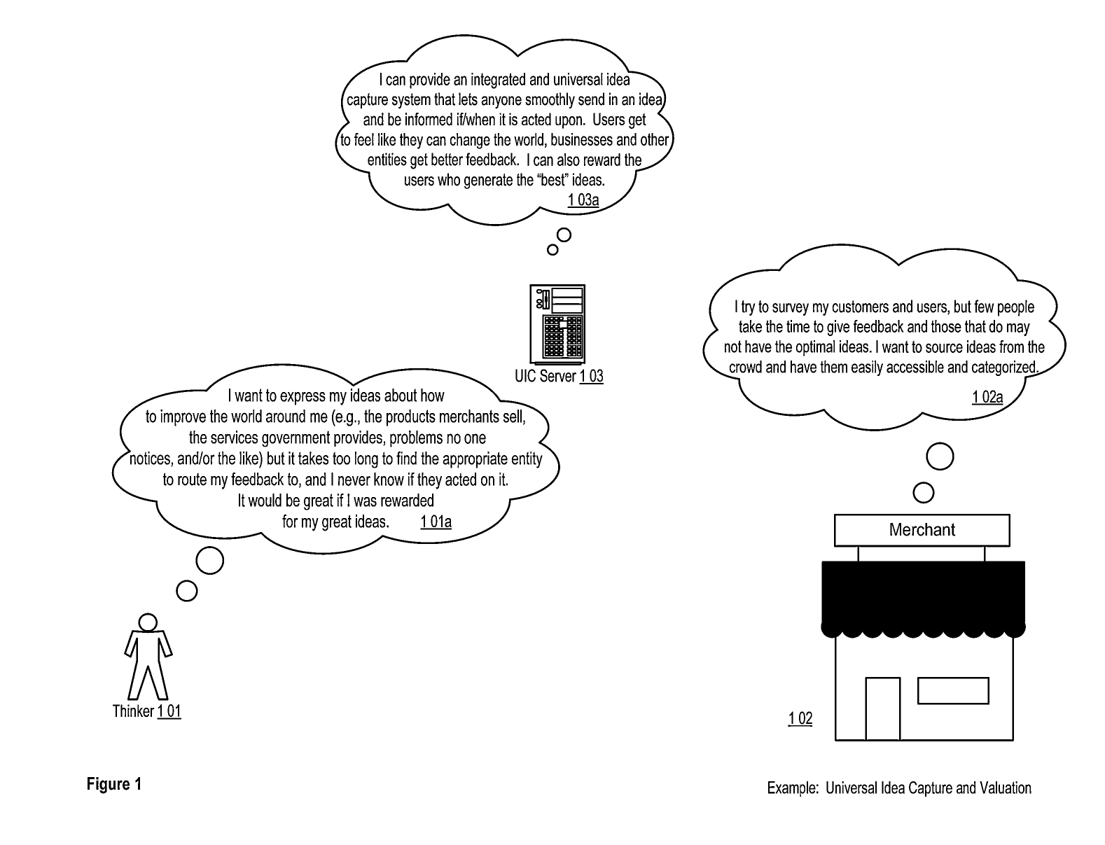

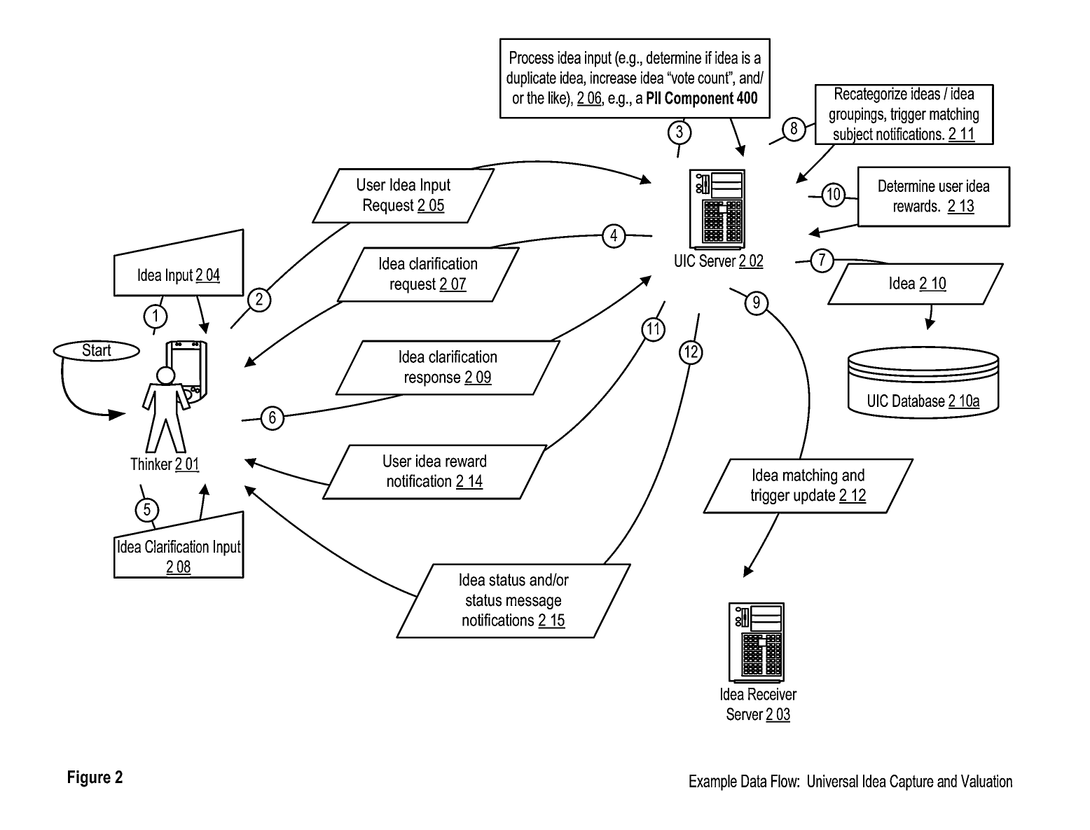

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### UIC

The UNIVERSAL IDEA CAPTURE AND VALUE CREATION APPARATUSES, METHODS AND SYSTEMS (hereinafter “UIC” user interface) transform the framework and content of web pages, via UIC components, in response to user browsing activities. In some embodiments, this is carried out in real time.

FIG. 1 shows a block diagram illustrating example aspects of a UIC. In one embodiment, thinker 101 may want to express their ideas, wishes, desires and the like about how to improve the world around them. For example, the user may have an idea regarding how a company may improve a product, how the user's local government may improve services, how a charity may solve a problem, and/or the like, e.g., 101a. In one embodiment, a subject (e.g., a merchant, local government, another individual, and/or the like), e.g., 102, may receive crowd sourced Need Want Associations, corresponding to a representation and/or aggregation of a plurality of wishes submitted by thinkers, e.g., 102a. In one embodiment, a UIC Server 103 may provide an integrated idea capture system that assists in the categorization, routing, valuation, and distribution of idea inputs, e.g., 103a.

FIG. 2 shows an example data flow illustrating aspects of universal idea capture and valuation, in one implementation of the UIC operation. In one embodiment, a thinker 201 may input an idea into their mobile device, e.g., idea input 204. In response to the idea input, the user device may prepare and transmit a user idea input request 205, containing the user idea to UIC server 202. An example user idea input request 205, substantially in the form of an HTTP(S) POST message including XML-formatted data, is provided below:

```
POST /user_idea_input_request.php HTTP/1.1
Host: www.UICserver.com
Content-Type: Application/XML
Content-Length: 667
<?XML version = ″1.0″ encoding = ″UTF-8″?>
<user_idea_input_request>
  <timestamp>2020-12-12 15:22:43</timestamp>
  <user_id>JD007<user_id>
  <user_name>John Doe</user_name>
  <device type=”iPhone5” id=”NEMC6565232” />
  <auth>
    <api key=”87KJHIUIUYGUY” />
    <certificate>
      &GHJHTYFDRTJDTRTRDTRFD
      *876CFDTRW#E#UYFYUKW#@
      LO*I&TRDFKHDRT$WGFVYIU
    </certificate>
  </auth>
  <idea>
    <subject>G&gle</subject>
    <wanted_solution>
          offer an option to specify a message is
          high priority
    </wanted_solution>
    <need_to_be_solved>
          respond timely to important messages
    </need_to_be_solved>
    <preferred_reward type=”donate_to_charity”
                preferred_charity=”Red Cross” />
    <post_on_social_media val=”true” />
    <notification_level>everything</notification_level>
    //optional field
    <other_entities>
      <entity user_specified_relation_strength=”75% similar”>
          Yahoo
      </entity>
    </other_entities>
</user_idea_input_request>
```

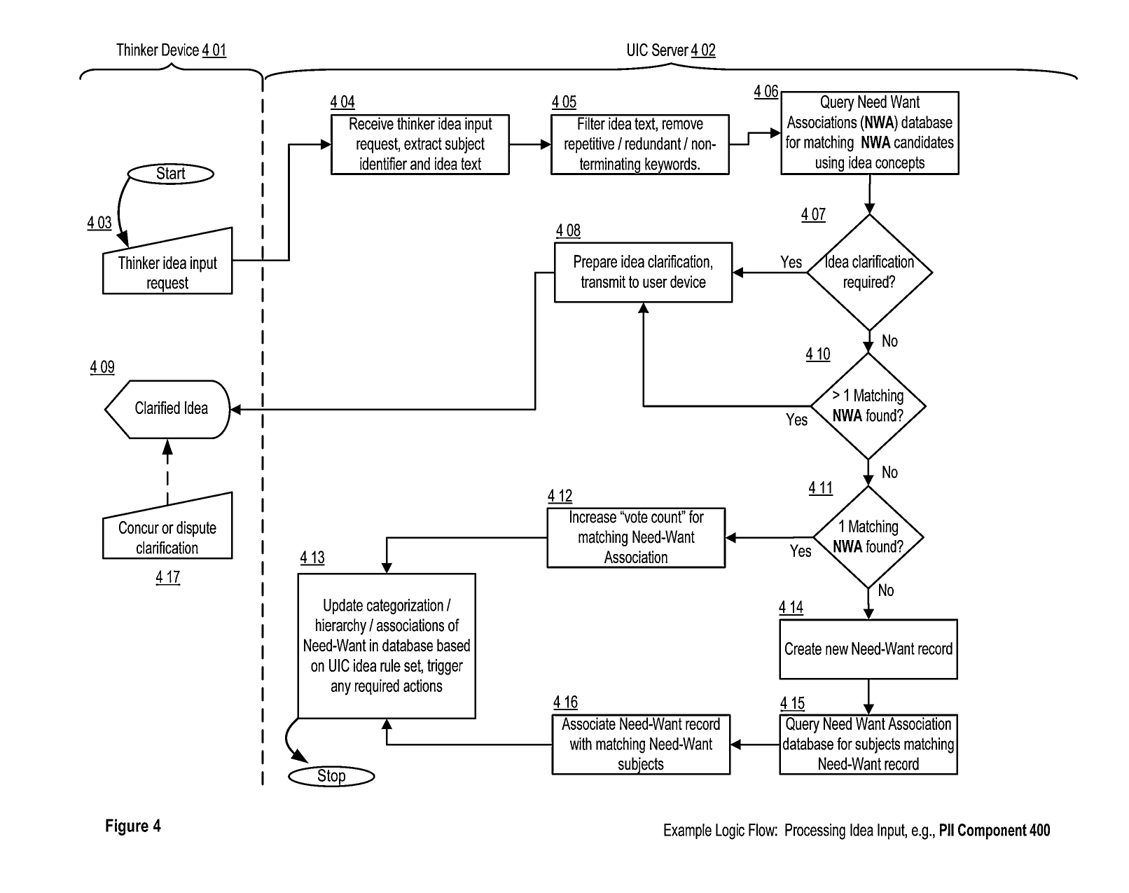

In one embodiment, the UIC server may process the idea input by, for example, extracting idea keywords, determining duplicate ideas, requesting idea clarification from the user, and/or the like, e.g., 206. Further detail with respect to user idea input request processing may be found herein and especially with respect to FIG. 4, e.g., an example PII Component 400. In one embodiment, the UIC server may request idea clarification. For example, multiple ideas may match the user's idea input, or the idea input may be ambiguous and/or undecipherable by the UIC. In one embodiment, the UIC server may prepare and transmit an idea clarification request 207. An example idea clarification request 207, substantially in the form of an HTTP(S) POST message including XML-formatted data, is provided below:

```
POST /UICServer_idea_clarification_request.php HTTP/1.1
Host: www.UserDevice.com
Content-Type: Application/XML
Content-Length: 667
<?XML version = ″1.0″ encoding = ″UTF-8″?>
<idea_clarification_request trackingNo=CR4682>
  <timestamp>2020-12-12 15:23:43</timestamp>
    <message_credentials type=”device_api_key”>
    <auth_key>h767kwjiwnfe456#niimidrtsxbi</auth_key>
  </message_credentials>
  <user_name>John Doe</user_name>
  <issue_intro> Our records shows the you have submitted an idea
directed to the subject: </issue_intro>
  <issue_object> G&gle </issue_object>
  <request_statement> Our system has found the subject for which
the below idea is directed undecipherable we would like you to
reenter a corrected subject for this idea </request_statement>
  <idea id=I7391>
    <subject>G&gle</subject>
    //other fields related to the idea may be sent back in case
the user wants to perform and editing
    <wanted_solution>
          offer an option to specify a message is
          high priority
    </wanted_solution>
    <need_to_be_solved>
          respond timely to important messages
    </need_to_be_solved>
    <preferred_reward type=”donate_to_charity”
                preferred_charity=”Red Cross” />
    <post_on_social_media val=”true” />
    //optional field
    <other_entities>
      <entity user_specified_relation_strength=”75% similar”>
          Yahoo
      </entity>
    </other_entities>
</idea_clarification_request>
```

In one embodiment, the user may provide a user clarification input 208, and the user's device may respond with an idea clarification response 209. An example idea clarification response 209, substantially in the form of an HTTP(S) POST message including XML-formatted data, is provided below:

```
POST /idea_clarification_response.php HTTP/1.1
Host: www.UICserver.com
Content-Type: Application/XML
Content-Length: 667
<?XML version = ″1.0″ encoding = ″UTF-8″?>
<user_clarification_response trackingNo=CR4682>
  <timestamp>2020-12-12 17:22:43</timestamp>
  <user_name>John Doe</user_name>
  <device type=”iPhone5” id=”NEMC6565232” />
  <auth>
    <api key=”87KJHIUIUYGUY” />
    <certificate>
      &GHJHTYFDRTJDTRTRDTRFD
      *876CFDTRW#E#UYFYUKW#@
      LO*I&TRDFKHDRT$WGFVYIU
    </certificate>
  </auth>
  <idea id=I7391>
    <corrected_subject>Google</corrected_subject>
    //the rest of the idea's field may remain intact if the user
decided to not make any changes.
    <wanted_solution>
          offer an option to specify a message is
          high priority
    </wanted_solution>
    <need_to_be_solved>
          respond timely to important messages
    </need_to_be_solved>
    <preferred_reward type=”donate_to_charity”
                preferred_charity=”Red Cross” />
    <post_on_social_media val=”true” />
    <notification_level>everything</notification_level>
    //optional field
    <other_entities>
      <entity user_specified_relation_strength=”75% similar”>
          Yahoo
      </entity>
    </other_entities>
</user_clarification_response>
```

In one embodiment, the idea may be stored in an idea UIC database 210a, e.g., 210. After or before storing the idea, the UIC may update idea parameters or associations, e.g., 211. For example, idea records may have strength associations that link them to other entities in the UIC database, such that some ideas are more strongly linked than other ideas. The addition of a new idea (or the “voting” of an idea already present) may involve updating one or more parameters. In one embodiment, the UIC server may transmit an idea-matching-and-trigger update e.g., 212 to an idea receiver server 203. An idea receiver may be an entity such as a merchant, a business, a government, and/or the like. An example idea-matching-and-trigger-update 212, substantially in the form of an HTTP(S) POST message including XML-formatted data, is provided below:

```
POST /idea_matching_trigger_update.php HTTP/1.1
Host: www.IdeaReceiverServer.com
Content-Type: Application/XML
Content-Length: 667
<?XML version = ″1.0″ encoding = ″UTF-8″?>
<idea_matching_trigger_update>
  <timestamp>2020-12-12 19:22:43</timestamp>
  <message_credentials type=”device_api_key”>
    <auth_key>mb432i54pomt6#niimidrtsxbi</auth_key>
  </message_credentials>
<user_data>
    <user_name>John Doe</user_name>
    <user_email>jd@myiw.con</user_email>
    <user_insightfulness_score> 9.5 </user_insightfulness_score>
</user_data>
<idea id=I7391>
    <notification_level>everything</notification_level>
    <subject>Google</subject>
    <wanted_solution>
          offer an option to specify a message is
          high priority
    </wanted_solution>
    <need_to_be_solved>
          respond timely to important messages
    </need_to_be_solved>
</idea_matching_trigger_update>
```

In one embodiment, once ideas reach a certain alert level, idea receivers may receive a notification to take action on an idea. Ideas below an alarm level may not generate an idea-matching-and-trigger update. In one embodiment, the UIC system may determine a user idea reward, e.g., 213, and transmit a user idea reward notification 214 to reward a user for submitting idea(s). An example user idea reward notification 214, substantially in the form of an HTTP(S) POST message including XML-formatted data, is provided below:

```
POST /user_idea_reward_notification.php HTTP/1.1
Host: www.UserDevice.com
Content-Type: Application/XML
Content-Length: 667
<?XML version = ″1.0″ encoding = ″UTF-8″?>
<user_idea_reward_notification>
  <timestamp>2020-12-12 21:23:43</timestamp>
    <message_credentials type=”device_api_key”>
    <auth_key>h767kwjiwnfe456#niimidrtsxbi</auth_key>
  </message_credentials>
  <user_name>John Doe</user_name>
  <reward_massage1> Congratulations! A hundred dollars have been
donated by Google to the Red Cross on your behalf for suggesting
the below idea </reward_message1>
  <idea id=I7391>
    <subject>Google</subject>
    <wanted_solution>
          offer an option to specify a message is
          high priority
    </wanted_solution>
    <need_to_be_solved>
          respond timely to important messages
    </need_to_be_solved>
  <reward_massage2> Your new insightfulness score is shown below,
thank you for contributing to make a better world!
</reward_message2>
  <insightfulness_score> 9.7 </insightfulness_score>
</user_idea_reward_notification >
```

In another embodiment, the thinker 201 may receive an idea status that indicates at what stage the idea is in a review process and/or if the idea has been considered relevant by an idea receiver and other status messages may include the thinker's current insightfulness score e.g., 215.

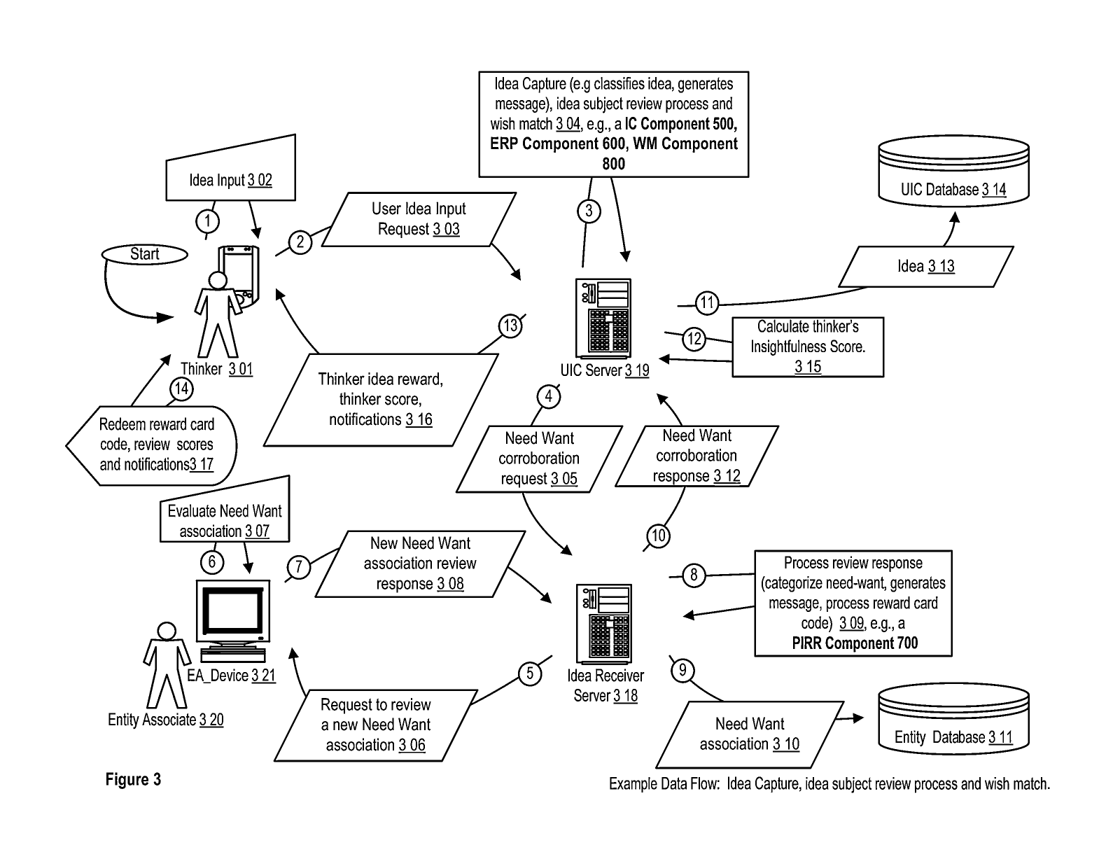

FIG. 3 shows an example data flow illustrating aspects of idea Capture, idea subject review process and wish match, in one implementation of the UIC operation. In one embodiment a thinker 301 may input an idea into their mobile device, e.g., idea input 302. In response to the idea input, the user device may prepare and transmit a user idea input request 303, containing the user idea to UIC server 319.

In one embodiment the UIC server may receive the user idea input request and may start a process to capture the idea, review the idea and verify if there is a subject for which the received idea matches an existing Want-Need association, e.g., 304. A subject may be an entity either (1) master or owned entity or (2) a category. A want may be an abstract representation of a solution to a problem. For example, “I want a bag I can wear on my back and that can hold numerous items.” A need may be an abstract representation of a problem, for example “I need to be able to easily carry numerous items with me”. Thereafter, the UIC server may send a Need Want corroboration request 305 to an Idea Receiver Server 318. An example Need Want corroboration request 305, substantially in the form of an HTTP(S) POST message including XML-formatted data, is provided below:

```
POST /need_want_corroboration_request.php HTTP/1.1
Host: www.IdeaReceiverServer.com
Content-Type: Application/XML
Content-Length: 667
<?XML version = ″1.0″ encoding = ″UTF-8″?>
<need_want_corroboration_request>
  <timestamp>2020-12-12 22:22:43</timestamp>
  <message_credentials type=”device_api_key”>
    <auth_key>mb432i54pomt6#niimidrtsxbi</auth_key>
  </message_credentials>
<user_data>
    <user_name>John Doe</user_name>
    <user_email>jd@myiw.con</user_email>
    <user_insightfulness_score> 9.5 </user_insightfulness_score>
</user_data>
<idea id=I7399>
    <status>Potential New Idea </status>
    <notification_level>everything</notification_level>
    <subject>Google</subject>
    <wanted_solution>
          build a free digital library containing orphan works
whose rights holders cannot be identified or located and, thus,
whose rights cannot be cleared
    </wanted_solution>
    <need_to_be_solved>
          provide universal wisdom and centralized human
knowledge in one single place
    </need_to_be_solved>
</need_want_corroboration_request>
```

In one embodiment, the Idea Receiver Server 318 may send a request to review a new Need Want association 306 to an Entity Associate e.g., 320 who is in direct communication with the EA computing device 321. An example request to review a new Need Want association 306, substantially in the form of an HTTP(S) POST message including XML-formatted data, is provided below:

```
POST / request_review_new_Need_Want_association.php HTTP/1.1
Host: www.EA_Device.com
Content-Type: Application/XML
Content-Length: 667
<?XML version = ″1.0″ encoding = ″UTF-8″?>
<request_review_new_Need_Want_association>
  <timestamp>2020-12-12 23:22:43</timestamp>
  <message_credentials type=”device_api_key”>
    <auth_key>za154754ghr654niim11456sxbi</auth_key>
  </message_credentials>
<entity_Associate_data>
    <EA_name>Larry Page</EA_name>
    <EA_employee_number>10516</EA_employee_number>
</entity_Associate_data>
<expected_answer_date>2021-01-01<expected_answer_date>
<idea id=I7399>
    <status>Potential New Idea </status>
    <notification_level>everything</notification_level>
    <subject>Google</subject>
    <wanted_solution>
          build a free digital library containing orphan works
whose rights holders cannot be identified or located and, thus,
whose rights cannot be cleared
    </wanted_solution>
    <need_to_be_solved>
          provide universal wisdom and centralized human
knowledge in one single place
    </need_to_be_solved>
</request_review_new_Need_Want_association >
```

In another embodiment, the Entity Associate 320 using EA Device 321 submits a Need-Want evaluation 307 and sends a new Need Want association review response, e.g., 308. An example new Need Want association review response 308, substantially in the form of an HTTP(S) POST message including XML-formatted data, is provided below:

```
POST /new_Need_Want_association_review_response.php HTTP/1.1
Host: www.IdeaReceiverServer.com
Content-Type: Application/XML
Content-Length: 667
<?XML version = ″1.0″ encoding = ″UTF-8″?>
<Need_Want_association_review_response>
  <timestamp>2021-01-01 08:17:20</timestamp>
  <message_credentials type=”device_api_key”>
    <auth_key>mb432i54pomt6#niimidrtsxbi</auth_key>
  </message_credentials>
<entity_Associate_data>
    <EA_name>Larry Page</EA_name>
    <EA_employee_number>10516</EA_employee_number>
    <EA_email>lp@gmail.com</EA_email>
    <EA_phone>(650)521-2657</EA_phone>
</entity_Associate_data>
<response>
<idea id=I7399>
<EA_remark>Feasible but not strategic</EA_remark>
<EA_reason> Obtaining permission to scan orphan works is
prohibited and even determining whether permission is needed is
prohibited </EA_reason>
</Need_Want_association_review_response >
```

Thereafter, the Idea Receiver Server 318 may process the review response. For example the Idea Receiver Server may categorize the Need-Want association, generate a customize message for Thinker 301 and/or generate a reward card code for the Thinker 301 as an appreciation for his/her input 309. In another embodiment, the Idea Receiver Server 318 may execute a command to store the received Need-Want association e.g., 310 in an Entity Database 311. In yet another embodiment, the Idea Receiver Server 318 may send a Need-Want corroboration response e.g., 312 to the UIC Server 319.

In one embodiment the UIC Server 319 may receive a Need-Want corroboration response and may store a corresponding idea e.g., 313 in a UIC Database 314. Thereafter the UIC Server 319 may calculate Thinker's 301 insightfulness score which ranks the contribution or impact of a Thinker on a Subject. Other Thinker's scores that may also be calculated are an overall insightfulness score 315 which is not associated with a particular subject but with all the subjects the Thinker has submitted ideas and an influencer score that may be calculated for Thinkers that have linked their UIC account to a social media application. The influencer score may be a function of the number of followers a Thinker may have, the frequency with which a Thinker shares things on social media applications and/or the average insightfulness score of all the wishes and or ideas submitted by the Thinker. In another embodiment, the UIC Server may send a reward card code, one or more thinker scores and notifications, e.g., 316. In yet another embodiment, Thinker 301 may redeem a reward card code, review one or more codes and notifications, e.g., 317.

FIG. 4 shows an example logic flow illustrating aspects of processing idea input, e.g., PII Component 400, in one implementation of the UIC operation. In one embodiment, Thinker device 401 may transmit a thinker idea input request 403 to UIC server 402. The UIC server may receive the idea input request and extract a subject identifier and idea text, e.g., 404. In one embodiment, idea text words that are redundant, repetitive or unnecessary for matching may be removed from the idea text using UIC idea processing and idea matching rules (such as, for example, an array of Regex expressions representing word or words for suppression), e.g., 405. In one embodiment, a Need-Want association candidate's database may be queried for matching Need-Want association, e.g., 406. If idea clarification is beneficial (for instance, if idea records associated with vastly different problems are found, no idea records are found, and/or the like), e.g., 407, an idea clarification 408 may be transmitted to the Thinker device and the thinker may view the clarified idea 409 and may decide to concur with the system's clarification or dispute with the provided clarification e.g., 417. In one embodiment, if more than one matching Need-Want association is found, the user may be asked to further clarify the idea, e.g., 410. If a matching Need-Want association is found, e.g., 411, the Need-Want association record vote value may be increased to take into account the additional Need-Want association vote, e.g., 412, and the Need-Want association categorization, hierarchy and/or the like updated, e.g., 413. In one embodiment, if no Need-Want association record is found, a new Need-Want association record may be created 414, and an entity database queried 415 for entities to associate with the new Need-Want association 416.

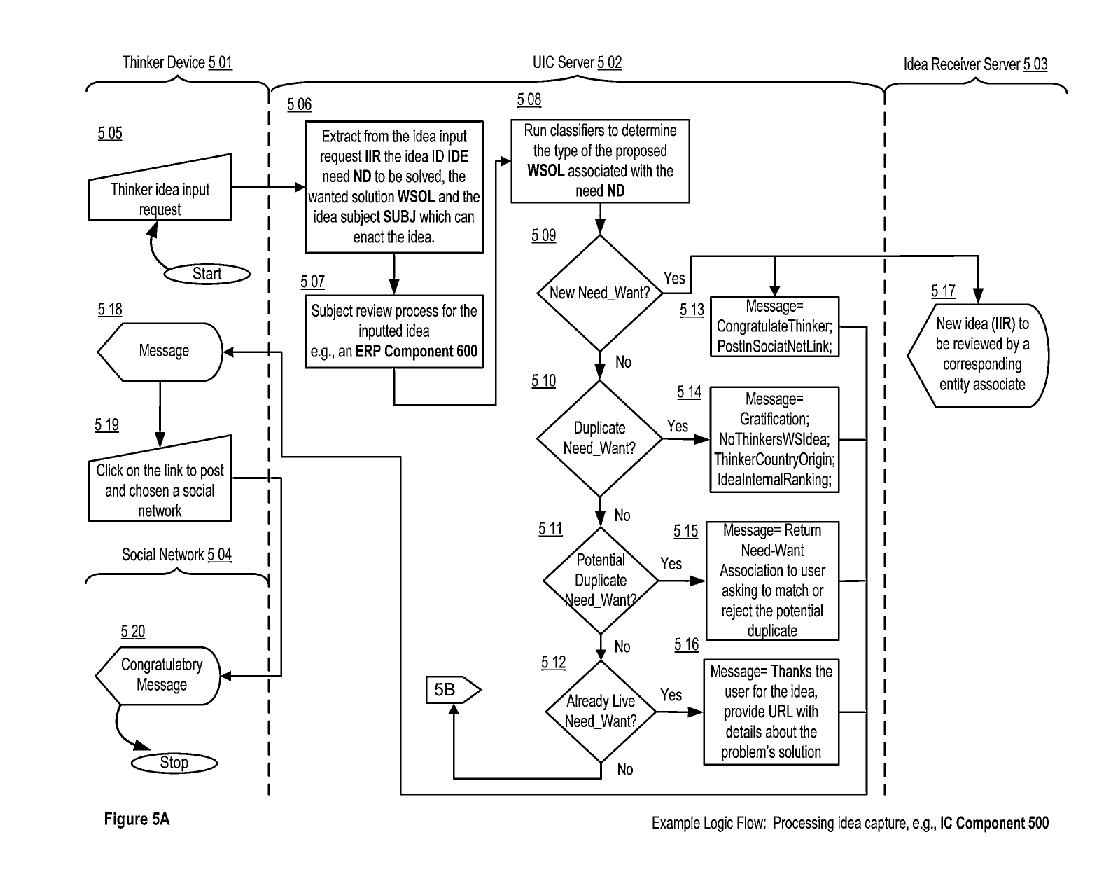

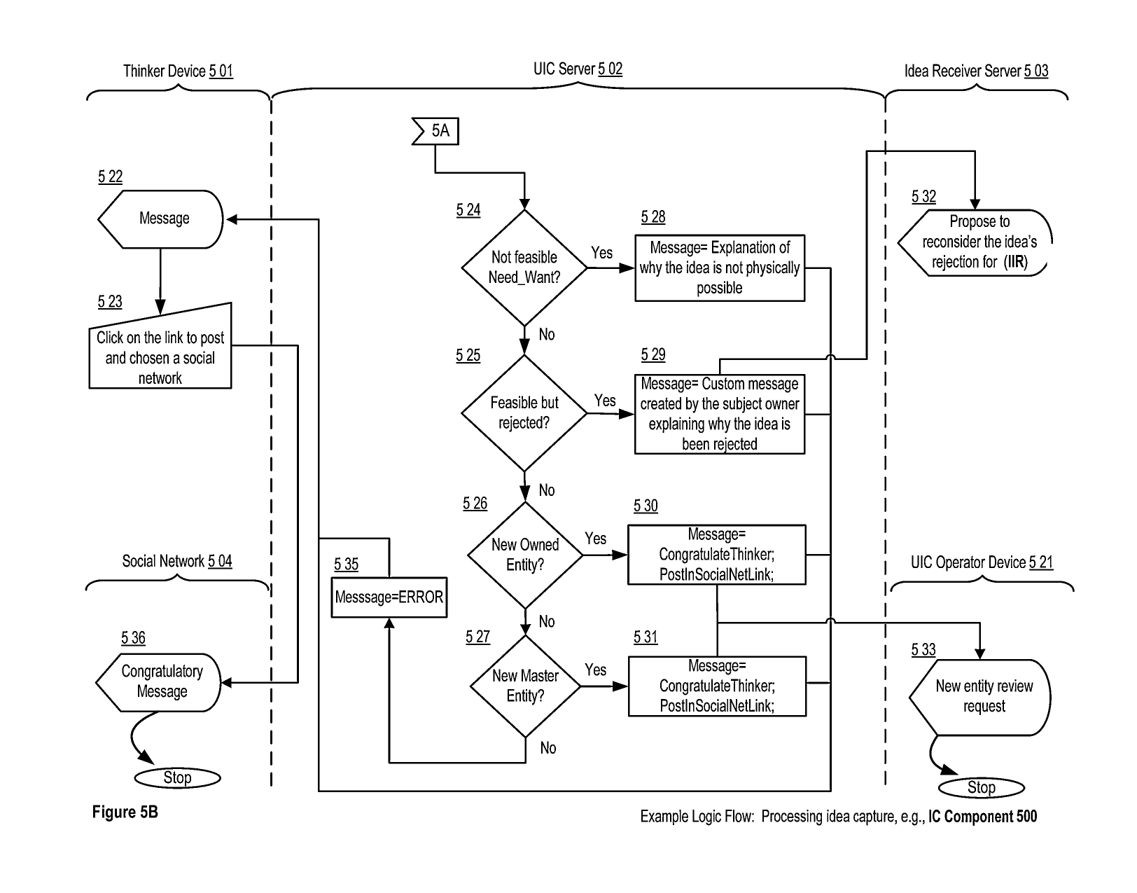

FIG. 5A-B shows an example logic flow illustrating aspects of processing idea capture, e.g., IC Component 500, in one implementation of the UIC operation. In one embodiment, the UIC server 502 may receive a thinker idea input request e.g. 505. Thereafter the UIC server may extract form the idea input request the idea IDE, a need to be satisfied ND, a wanted solution to satisfy the need WSOL and the idea subject SUBJ which is the entity that can enact the idea or to which the idea can be enacted upon e.g., 506. In another embodiment, the UIC server may perform a subject review process 507 for the inputted idea e.g., an ERP Component 600 which will be describe further in this specification. In yet another embodiment, the UIC server may run a plurality of classifiers to determine what type of WSOL and need ND are associated with the idea submitted by the Thinker e.g., 508.

In one embodiment the Need-Want association corresponding to the inputted idea may be a new Need-Want association e.g., 509, in such case a message content is generated to congratulate the corresponding Thinker the message can include a link to post the congratulatory message on the Thinker's preferred social network application, e.g., Facebook, Twitter, Tumblr and or the like e.g., 513. Thereafter, the new idea is sent to an Idea Receiver Server 503 to be reviewed by an entity associate affiliated with the subject SUBJ specified in the inputted idea e.g., 517.

In one embodiment, the Need-Want association corresponding to the inputted idea may be a duplicate e.g., 510, in such a case, message content is generated with a greetings to the corresponding Thinker, the number and demographics of Thinkers that have submitted the same idea, and the idea relevant rankings within the system e.g., 514. In another embodiment, the Need-Want association corresponding to the inputted idea may be classified as a potential duplicate, e.g., 511; in such a case, message content is generated asking the corresponding user to confirm if the submitted idea is indeed an instance of the Need-Want association already registered in the system e.g., 515. In yet another embodiment, the Need-Want association corresponding to the inputted idea may be classified as an idea that is already live, i.e., the wanted solution has already been implemented for the specified need, e.g., 512, in such a case, a message is generated thanking the Thinker for his/her contribution comprising a URL link to a page containing details regarding the implemented solution, e.g., 516.

In one embodiment, the Need-Want association corresponding to the inputted idea may be already registered as not feasible e.g., 524, in such a case, message content comprising an explanation of why the idea is not physically possible is generated to be sent to the corresponding Thinker e.g., 528. In another embodiment, the Need-Want association corresponding to the inputted idea may be already registered in the system as feasible but rejected by the corresponding subject, e.g., 525, in such a case, message content congratulating the corresponding Thinker is generated comprising an explanation why the idea is currently rejected by the corresponding subject, e.g., 529. Thereafter a proposal to reconsider the rejected idea may be send to the corresponding Idea Receiver Server 503, e.g., 532.

In one embodiment the Need-Want association corresponding to the inputted idea may be directed to an owned entity not catalogued in the UIC system, e.g., 526, in such a case, message content congratulating the corresponding Thinker for submitting the idea and expanding the UIC catalog is generated including a link to post the congratulatory message on the Thinkers preferred social network application e.g., Facebook, Twitter, Tumblr and or the like e.g., 530. Thereafter, a new entity review request may be sent to a UIC operator device 521 e.g., 533 wherein the UIC system may acquire information about the related subject including but not limited to business type e.g., B2B, B2C, number of employees, markets, aliases, product lines, type of service, infrastructure, location and the like. In another embodiment, the Need-Want association corresponding to the inputted idea may be directed to a Master Entity not registered in the UIC system e.g., 527, in such case content congratulating the corresponding Thinker for submitting the idea and expanding the UIC catalog is generated including a link to post the congratulatory message on the Thinkers preferred social network application e.g., Facebook, Twitter, Tumblr and or the like e.g., 531. Thereafter, a new entity review request may be sent to a UIC operator device 521 e.g., 533 wherein the UIC system may acquire information about the related subject including but not limited to business type e.g., B2B, B2C, number of employees, markets, aliases, product lines, type of service, infrastructure, location and the like. In yet another embodiment, when a type is not defined by any of the types verified in 509, 510, 511, 512, 524, 525, 526 and 527, then the UIC server may generate message content specifying that there is an error in the classifier system e.g., 535.

In one embodiment, a message is sent by the UIC server 502 to the Thinker device 501, e.g., 518 and 522. Thereafter the Thinker device 501 may receive and input, e.g., 519 and 523, corresponding to a click on a link to post the message on a chosen social network application, e.g., 504. In another embodiment, the message may be posted in a social network application, e.g. 520 and 536.

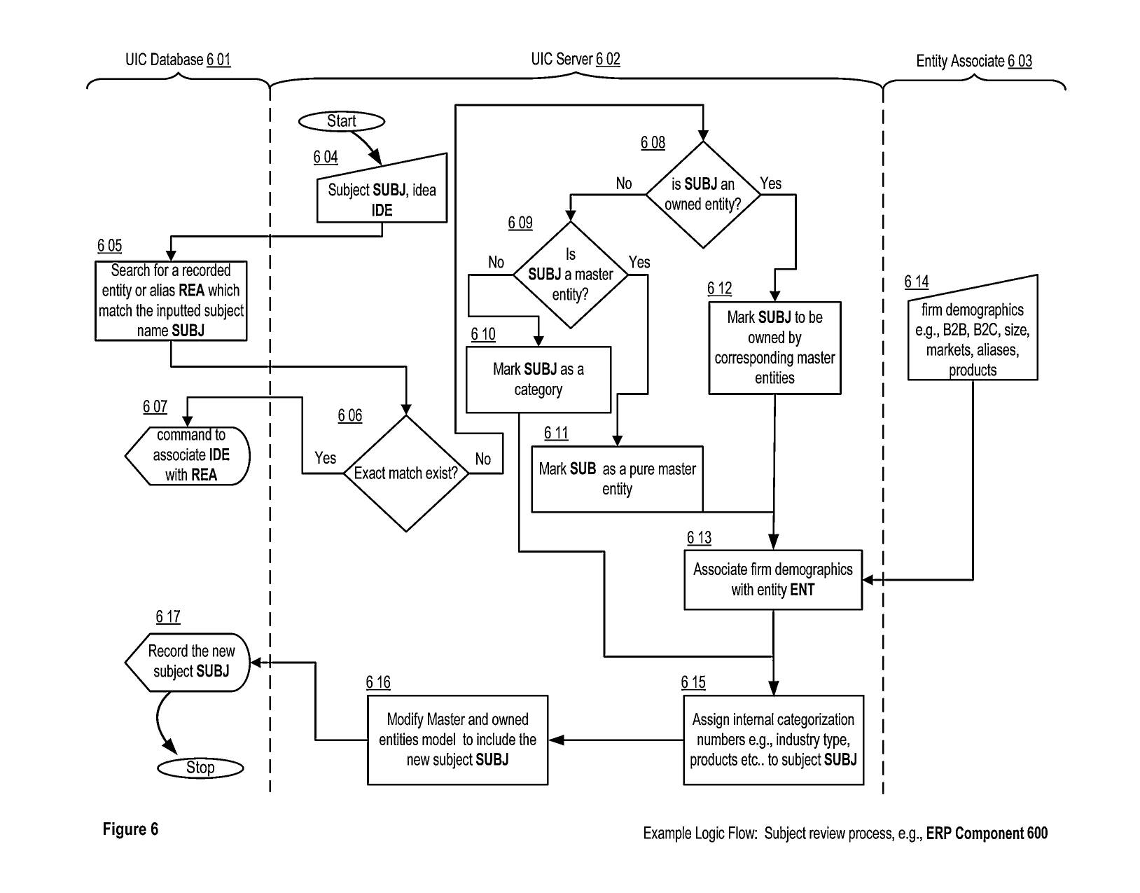

FIG. 6 shows an example logic flow illustrating aspects of subject review process, e.g., ERP Component 600, in one implementation of the UIC operation. In one embodiment a UIC database 601 may receive from a UIC Server 602 a subject SUBJ and an idea IDE related to the subject, e.g., 604. In another embodiment, the UIC database may receive a command to search for a recorded entity or alias REA that match the inputted subject name SUBJ, e.g., 605.

In one embodiment the UIC server 602 may verify if there is an exact match between the inputted subject and a corresponding recorded entity or alias REA e.g., 606. If an exact match exists, e.g., 606, then the UIC server 602 may send a command to the UIC database to associate the idea IDE with the matching recorded entity or alias REA 607. If there is no exact match between a subject and a corresponding recorded entity or alias REA, e.g., 606, then the UIC server 602 may verify if the subject SUBJ corresponds to a new owned entity, e.g., 608.

If the subject SUBJ corresponds to a new owned entity then, the UIC server 602 may associate the subject SUBJ with one or more suitable master entities 612. In one embodiment, such assignment may be performed by traversing a master-owned entity branch to a master entity that can precisely own the new subject SUBJ. To clarify this feature, the following example is presented; having a branch structure of a Subject model describing master-owned entity relations, e.g., (Parks in New York)->(Parks in Manhattan)->(Central Park)->(Northeast area) a Thinker may submit the following idea, I wish Central Park had a safe area for exotic reptiles so my corn snake and I can enjoy outdoor activities. Deconstructing the aforementioned idea the need to be solved ND is to enjoy outdoors activities with a corn snake, the wanted solution WSOL is a safe area for exotic reptiles and the subject SUBJ is Central Park. Now given the exemplary master-owner entity branch structure the branch structure may be traversed starting on Central Park, it will make logical sense to mark the wanted solution to be owned by the entity Central Park. Central Park however, may own other entities, e.g., Northeast area as shown in the example structure may be a more accurate candidate subject, and similarly a Northwest, Southwest and Southeast areas also owned by Central Park. In such case the Subject model is traversed and the subject a safe area for exotic reptiles may be marked as to be owned by the master entities Northeast, Northwest, Southeast and Southwest areas owned by the master entity Central Park in such way the UIC catalogue may increase its registered entities from new ideas inputted by Thinkers. Thereafter, if applicable the UIC server 602 may receive, e.g., 613 entity demographics 614 from an entity associate 603 that are dependent on the nature of the newly catalogued entity, which may include but not limited to business type, e.g., B2B, B2C, number of employees, markets, aliases, product lines, type of service, infrastructure, location and the like.

In one embodiment the SUBJ may not be an owned entity but instead it may be a pure master entity, e.g., 609. A pure master entity is not owned by any other entity therefore it may be marked as pure master entity to eventually be added to the master-owner entity structure as a master entity with no parent entities i.e., an entity that is a root for other owned and master-owned entities, e.g., 611. Thereafter, if applicable, the UIC server 602 may receive, e.g., 613 entity demographics 614 from an entity associate 603 that are dependent on the nature of the newly catalogued entity which may include but not limited to business type, e.g., B2B, B2C, number of employees, markets, aliases, product lines, type of service, infrastructure, location and the like.

In one embodiment, the SUBJ for which the need to be solved ND and the wanted solution WSOL is directed may not be either an owned or master entity. Instead the SUBJ may be directed towards an abstract entity for example non-profit organizations in general, government institutions, public figures, business and the like, in such a case the subject SUBJ is marked as a category which will eventually be added to the Subject model under the categories section, e.g., 610. In another embodiment, the abstract entities may refer to lower level categories e.g., retail banks, improvisation theater groups and the like categories.

In one embodiment, after either steps 610, 611 or 613 have been executed the internal categorization numbers may be assigned depending on the entity type to the new catalogued subjects including but not limited to industry type, mission, flagship products, targeted customers and the like 615. Thereafter the new subject SUBJ may be integrated to the Subject/Master and owned entities model 616 according to the marked positions defined in steps 610, 611, 612 and 613. In another embodiment, the UIC server 602 may output the new subject SUBJ 617 to be recorded in the UIC Database 601.

In another embodiment, the subject may be a User Specific Subject which may be expressed employing a user defined alias e.g., “my husband” and may be linked to a Thinker's username. In another embodiment, the UIC system may send ideas and or wishes to the User Specific Subject e.g., “I wish my husband would get us a reservation at Trio Grill” or “I wish I would buy a USB mini speaker”. In yet another embodiment, the specified wishes may be communicated to the User Specific Subject via email, text message, phone message and or the like communications.

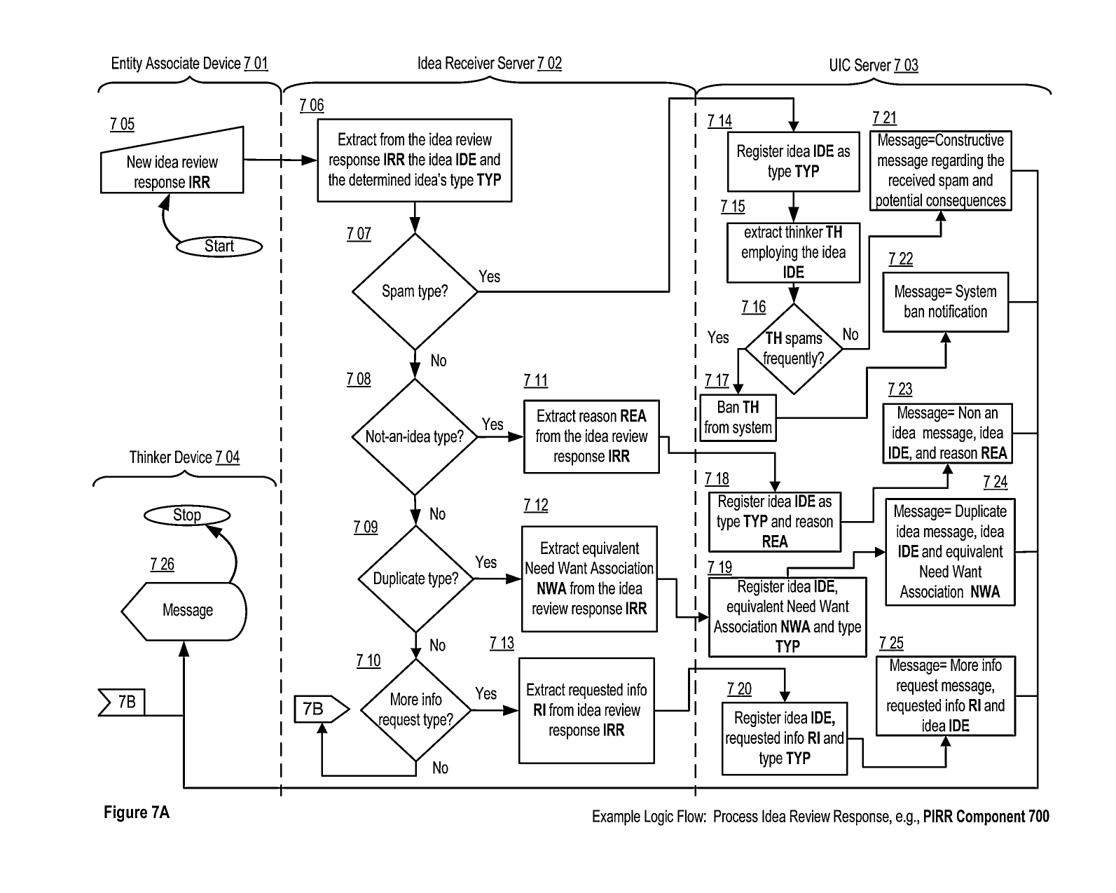

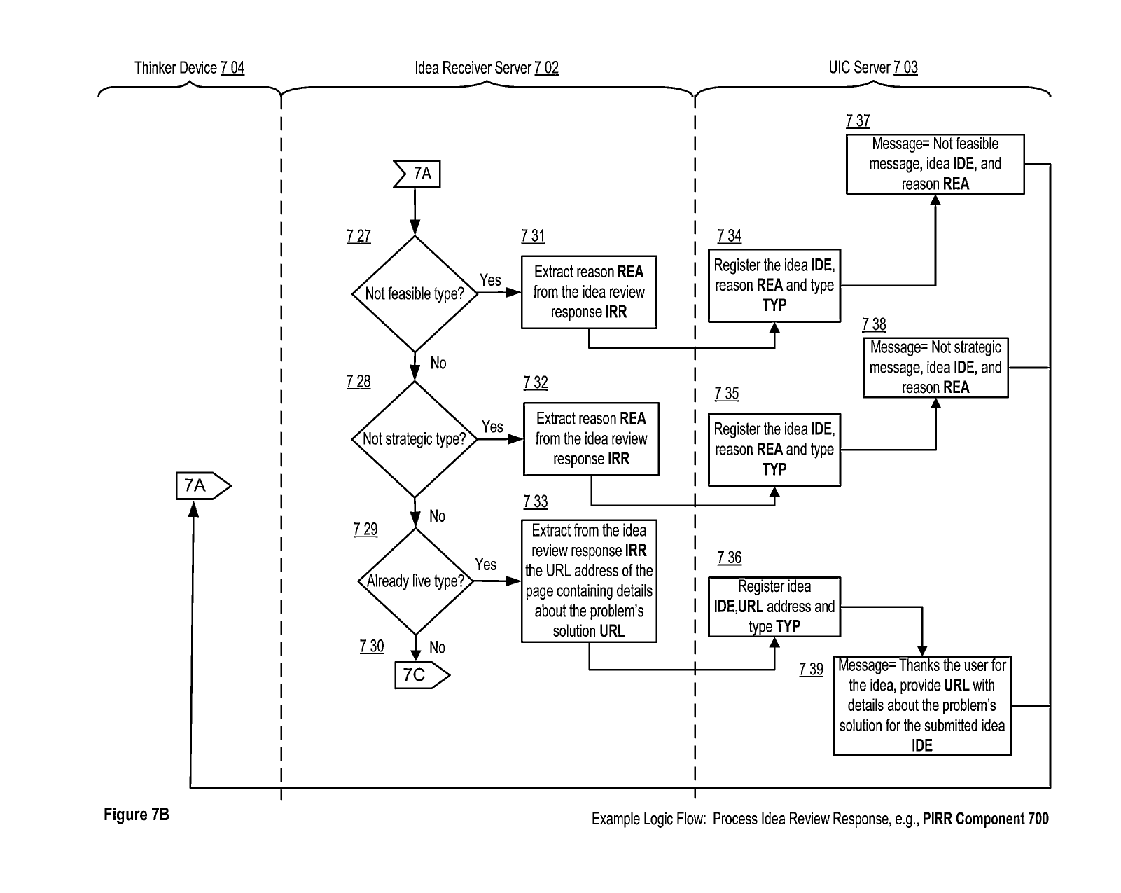

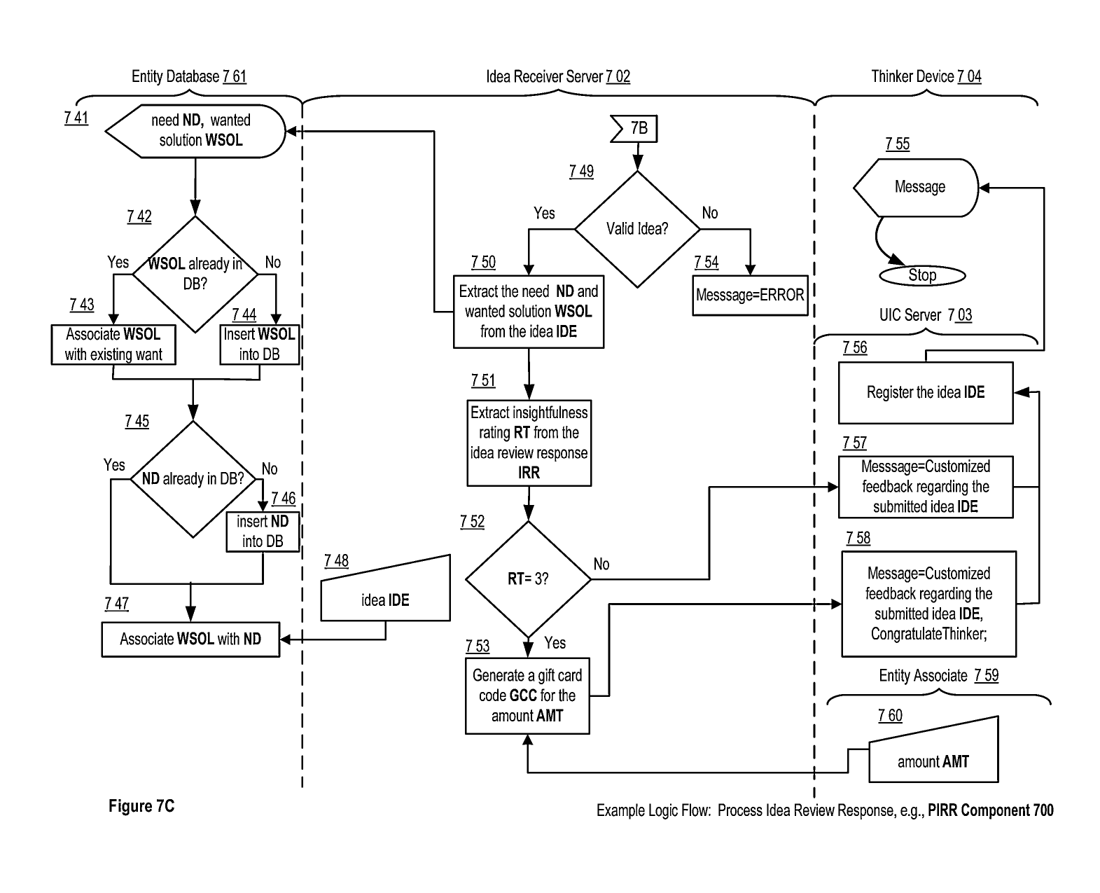

FIG. 7A-C shows an example logic flow illustrating aspects of process idea review response, e.g., PIRR Component 700, in one implementation of the UIC operation. In one embodiment, an Idea Receiver Server 702 may receive a new idea review response IRR 705 from an entity associate device 701. Thereafter, the Idea Receiver Server 702 may extract from the idea review response IRR the idea IDE and the determined idea's type TYP 706.

In one embodiment, the idea type TYP is analyzed and it may have been classified as spam, e.g., 707 then the idea IDE is sent to the UIC Server 703 and thereafter the UIC Server 703 may register the idea as Spam e.g., 714 and extracts the author of the idea i.e., Thinker TH from the information contained in the idea IDE, e.g., 715. In another embodiment, it is verified how frequently the Thinker TH sends spams to the UIC server 703, if the Spamming rate is determined to be frequent, e.g., 716, the thinker TH is banned from the system, e.g., 717 and message content is generated including a system ban notification, e.g., 722. However, if the Thinker TH does not submit spam frequently to the UIC system, e.g., 716, then message content is generated including a constructive notice regarding the received message and potential consequences if spam keeps being received from the author Thinker TH, e.g., 721.

In one embodiment, the idea type TYP is analyzed and it may have been classified as not an idea, e.g., 708. Then if so, the reason REA explaining why the idea was classified as not an idea is extracted from the response IRR 711. Thereafter, the idea IDE, the type TYP and the reason REA are sent to the UIC server 703 to be registered in its records, e.g., 718. In another embodiment, the UIC server 703 may generate message content including a notice explaining the submitted idea was not considered a valid idea along with the reason, e.g., 723.

In one embodiment, the idea type TYP is analyzed and it may have been classified as a duplicate idea e.g., 709. Then if so, a corresponding Need Want association is extracted from the idea review response, e.g., 712. Thereafter, the idea IDE, the corresponding Need Want association NWA and type TYP i.e., duplicate idea are sent to the UIC server to be registered, e.g., 719. In another embodiment, message content is generated including a duplicate idea notice, the submitted idea IDE and the corresponding/equivalent Need Want association, e.g., 724.

In one embodiment, the idea type TYP is analyzed and it may have been classified as a more information request type, e.g., 710. Then if so, the more-information request is extracted from the idea review response IRR, e.g., 713. Thereafter, the idea IDE, the requested information IR and the type TYP are send to the UIC server to be registered, e.g., 720. In another embodiment, message content is generated including a request for more information, the requested information IR and the related idea IDE, e.g., 725.

In one embodiment, the idea type TYP is analyzed and it may have been classified as not feasible type, e.g., 727, then a reason REA is extracted from the idea review response IRR, e.g., 731. Thereafter, the idea IDE, the reason REA and the type TYP are sent to the UIC server 703 to be registered e.g., 734. In another embodiment, message content is generated including a not feasible notice for the idea IDE and the reason REA, e.g., 737.

In one embodiment, the idea type TYP is analyzed and it may have been classified as a not strategic type which means that the idea is feasible however the subject SUBJ for which the idea is directed does not considered to be align with the subject SUBJ business strategy, policy, mission and/or the like reasons, e.g., 728, then the reason is extracted from the idea review response IRR, e.g., 732. Thereafter, the idea IDE, the reason REA and the type TYP are sent to the UIC server to be registered e.g., 735. In another embodiment, message content with a not strategic notice is generated including the corresponding idea IDE and the reason REA why the idea is considered to be not strategic e.g., 738.

In one embodiment, the idea type TYP is analyzed and it may have been classified as an already alive type, i.e., the idea has been already implemented e.g., 729, a URL address is extracted from the idea review response such URL address corresponds to a page where details about how the idea has been implemented can be view by the Thinker who authored the idea e.g., 733. Thereafter, the idea IDE, the type TYP and the URL address are sent to the UIC server to be registered, e.g., 736. In another embodiment, message content is generated thanking the Thinker who submitted the idea including the URL where information about how the idea has been implemented may be found, e.g., 739.

In one embodiment, if the idea type TYP is not any of the types verified on steps 707, 708, 709, 710, 727, 728, or 729, e.g., 730 then a message 726 with content generated in previous steps is sent to a thinker device 704.

In one embodiment, the idea type TYP is analyzed and it may have been classified as a valid idea e.g., 749, then the problem that need to be solved ND and the wanted solution WSOL are extracted from the idea IDE, e.g., 750. Thereafter the ND and WSOL are sent to the corresponding entity database 761, e.g., 741. In another embodiment, the wanted solution WSOL is tested to verify if it is already registered in the entity database, e.g., 742. If it is already registered in the entity database, then the WSOL is associated with the already registered want, e.g., 743. However, if the WSOL is not registered in the entity database yet, e.g., 742, then the WSOL is inserted into the entity database, e.g., 744. In yet another embodiment, the need ND is tested to verify if it is already registered in the entity database, e.g., 745. If the ND is not already in the entity database, then the need ND is inserted in the entity database, e.g., 746. Thereafter, the wanted solution WSOL is associated with the need ND, e.g., 747. Similarly if the need is already registered in the entity database, e.g., 745, the wanted solution is associated with the need ND, e.g., 747. Thereafter, the idea IDE is sent to the idea receiver server 702 e.g., 748.

In one embodiment, after step 750, the idea receiver server may extract an insightfulness rating score RT from the idea review response IRR, e.g., 751. Thereafter, the value of the rating score is tested, for example is the value is equal to 3, e.g., 752, then a gift card code GCC valid for an amount AMT specified by an entity associate 759, e.g., 760 is generated e.g., 753. In another embodiment, message content including a customized feedback regarding the submitted idea IDE and a congratulatory statement directed to the thinker who authored the idea is generated, e.g., 758 by the UIC server 703. In yet another embodiment, the rating RT may not be equal to 3, e.g., 752, then a message content including a customized feedback regarding the submitted idea IDE 757 is generated by the UIC server 703.

In one embodiment, after either the steps 757 or 758, the idea IDE is registered in the UIC Server 756. Thereafter a message with predefined content is sent to the Thinker 704.

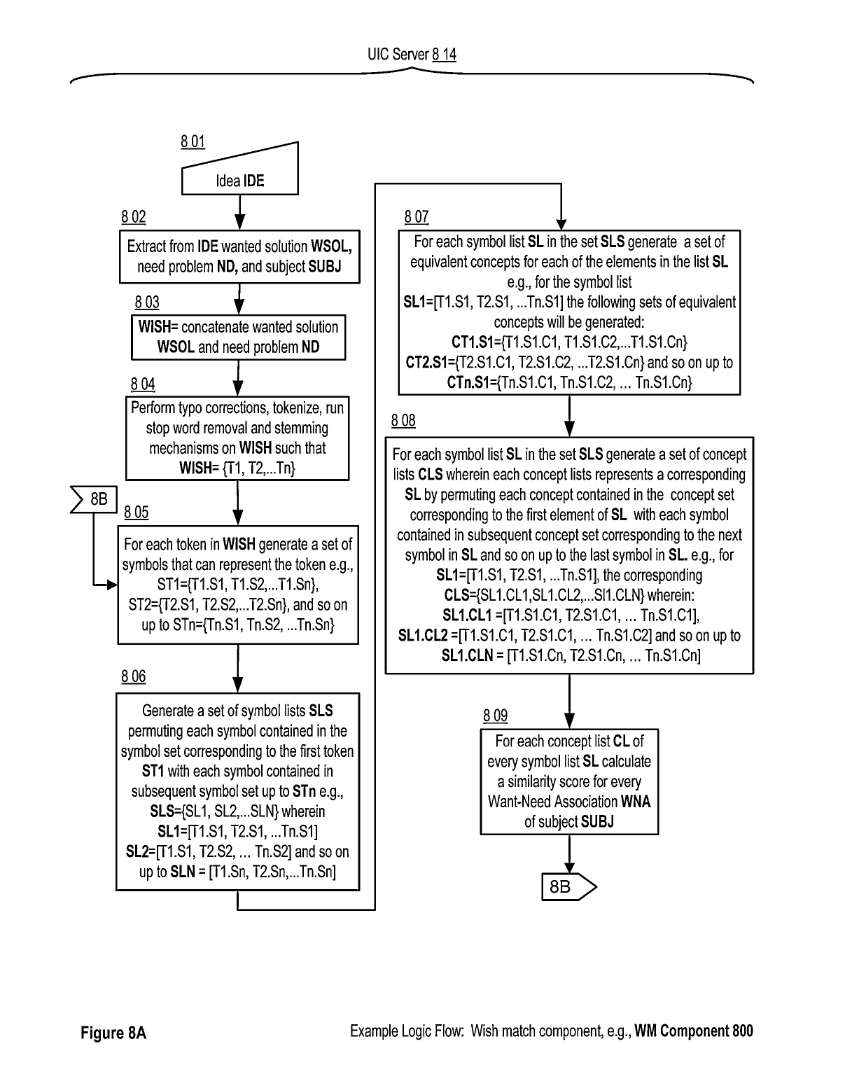

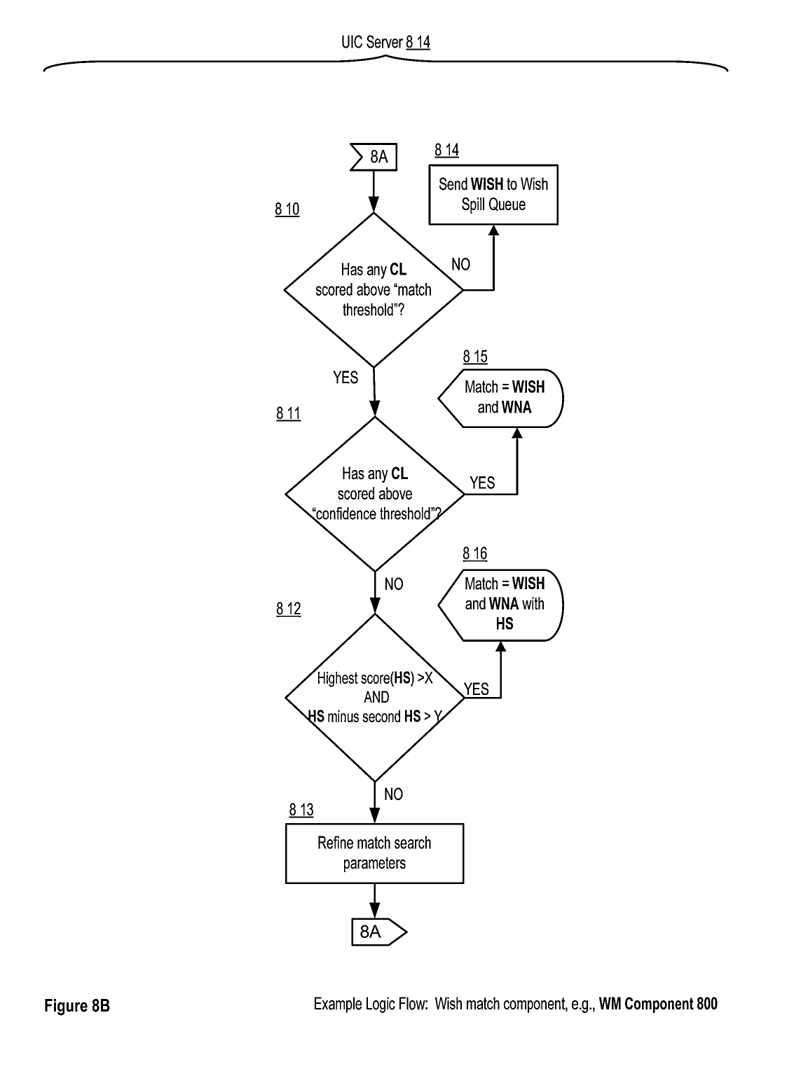

FIG. 8A-B shows an example logic flow illustrating aspects of wish match component, e.g., WM Component 800, in one implementation of the UIC operation. In one embodiment, an idea IDE is received by the UIC server 814 e.g., 801. Thereafter, the wanted solution WSOL, the need problem ND and the subject SUBJ are extracted form the idea IDE, e.g., 802. In another embodiment the wanted solution WSOL is concatenated to the need problem ND to make a third structure named WISH, e.g., 803. In yet another example several operation may be performed on the WISH structure including typo corrections, tokenization, stopword removals, (“stopwords” are words or groups of words that occur very commonly and are usually unconnected to the information being sought) and stemming mechanisms such that at the end of the step the structure WISH may contain a set of tokens e.g., WISH={T1, T2, . . . Tn}e.g., 804.

In one embodiment, for each token in WISH a set of symbols that can represent the token e.g., ST1={T1.S1, T1.S2, . . . T1.Sn}, ST2={T2.S1, T2.S2, . . . T2.Sn}, and so on up to STn={Tn.S1, Tn.S2, . . . Tn.Sn} is generated e.g., 805. In another embodiment, a set of symbol lists SLS permuting each symbol contained in the symbol set corresponding to the first token ST1 with each symbol contained in subsequent symbol set up to STn e.g., SLS={SL1, SL2, . . . SLN} wherein SL1=[T1.S1, T2.S1, . . . Tn.S1], SL2=[T1.S1, T2.S2, . . . Tn.S2] and so on up to SLN=[T1.Sn, T2.Sn, . . . Tn.Sn] is generated e.g., 806. In yet another embodiment, for each symbol list SL in the set a set of equivalent concepts for each of the elements in the list SL is generated e.g., for the symbol list SL1=[T1.S1, T2.S1, . . . Tn.S1] the following sets of equivalent concepts will be generated: CT1.S1={T1.S1.C2, . . . T1.S1.Cn}, CT2.S1={T2.S1.C1, T2.S1.C2, . . . T2.S1.Cn} and so on, up to CTn.S1={Tn.S1.C1, Tn.S1.C2, . . . Tn.S1.Cn}e.g., 807.

In one embodiment, for each symbol list SL in the set SLS a set of concept lists CLS wherein each concept lists represents a corresponding SL by permuting each concept contained in the concept set corresponding to the first element of SL with each concept contained in the concept set corresponding to the next symbol in SL and so on up to the last symbol in SL is generated e.g., 808. For example for SL1=[T1.S1, T2.S1, . . . Tn.S1], the corresponding sets of equivalent concepts are CT1.S1={T1.S1.C1, T1.S1.C2, . . . T1.S1.Cn}, CT2.S1={T2.S1.C1, T2.S1.C2, . . . T2.S1.Cn} and so on, up to CTn.S1={Tn.S1.C1, Tn.S1.C2, . . . Tn.S1.Cn} wherein the set of concept lists is CLS={SL1.CL1,SL1.CL2, . . . S1.CLN} and wherein SL1.CL1=[T1.S1.C1, T2.S1.C1, Tn.S1.C1], SL1.CL2=[T1.S1.C1, T2.S1.C1, . . . Tn.S1.C2] and so on up to SL1.CLN=[T1.S1.Cn, T2.S1.Cn, . . . Tn.S1.Cn]e.g., 808.

In one embodiment, for each concept list CL in CLS (i.e., each concept list of every symbol list SL) the UIC server may calculate a similarity score for every Want-Need Association of subject SUBJ e.g., 809. Thereafter the score obtained by each of the concept lists CLs in the concept list set CLS may be evaluated e.g., 810, if none of the CLs scored above a predetermined match threshold then the WISH may be sent to a Wish Spill Queue e.g., 814. If at least one concept list CL has reached the match threshold then the scores may be evaluated again to verify if any concept list CL has scored above a predefined confidence threshold e.g., 811. Once a concept list has reached the confidence threshold, the system matches the WISH with the Wanted-Need Association for which the WISH scored the higher or equal to the confidence value e.g., 815. If there is no match between any of the concept lists CLs and any of the Want-Need Associations of the corresponding subject SUB, the UIC server may calculate if the difference between the highest similarity score and the second highest similarity score of any of the CLs with any of the Want-Need Associations corresponding to the subject SUBJ is less than a predetermined threshold e.g., 812 the UIC server may match the WISH with the Want-Need Association which produce the highest score e.g., 816.

In one embodiment, when none of the concept lists CLs scored above a confidence threshold e.g., 811 and there is no case for which the difference between the highest similarity score and the second highest similarity score of any of the CLs with any of the Want-Need Associations corresponding to the subject SUBJ is less than a predetermined threshold e.g., 812, then the UIC server may refine the match search parameters e.g., 813. For example, in one embodiment, similarity scores for every Need Want Association in every Subject that the Idea's Subject belongs to (e.g. an Idea sent to “iPhone” could match to a Need Want Association for “Apple”, “smartphone”, or “consumer electronics”) may be calculated and then repeat the process starting from step 805. Alternatively or additionally, the parameters may be modified such the search may be expanded on the Subject model and the process may be repeated starting from step 805. In another embodiment, WISH may be send to the Wish Spill Queue.

In one embodiment a similarity score may be calculated by the score of each Concept in a Concept List is given by:

```
partial-score(list_concept, concept_structure) =
      if (none of the List Concept's neighbors on the Concept Graph is
present in the Concept Structure), generic negative “missing” score;
      else,
        Concept Structure weight for matched concept * total weight
based on Concept Graph distance, type, and strength;
```

and the total score may be the sum of all partial scores for each CL concept, with a penalty for any Concept Structure concept that's ultimately missing.

In one embodiment the symbols and concepts used to generate the set may be contextually relevant to the subject of the Need Want Association.

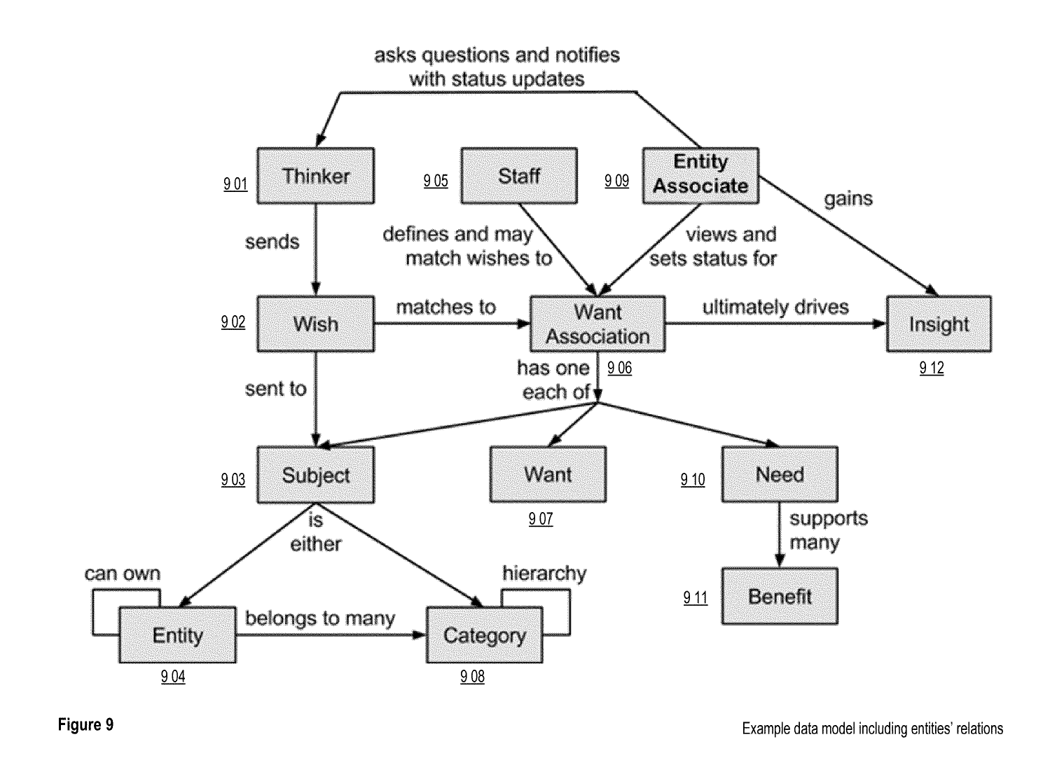

FIG. 9 shows an example data model including entities' relations, in one implementation of the UIC operation. In one embodiment a Thinker 901 may be a user who submits ideas comprising wishes to the system. A Wish 902 may be submitted by a Thinker directed to a Subject, expressing a desire for something to happen. Made of Subject Text and Wish Text. In one embodiment a Wish processing may comprise the entire lifecycle of a new Wish, from “just submitted” to “matched with a Subject and Want Association and the Thinker gets a notification”. May include input from various matching algorithms as well as Data Curators and/or Data Sorters. A Subject 903 may be anything that can be the X (grammatically, the object . . . ) in “I wish X would Y”. An Entity 904 may be a Subject that's made of one or more people acting as a unified whole. Examples include but are not limited to businesses, government agencies, public figures, and non-profits and the like. Entities may implement Wants. A Product may refer to a particular Entity that must belong to an organization Entity. It may be a physical good or a service. This is a brand unique to its parent Entity, not a type of product like “shoes” (which may be a Good and Service, a type of Category). A Category 908 may refer to a Subject that contains many other Subjects which don't act as a unified whole. Examples include but are not limited to goods and services, industries, and demographics. Categories may not be able to implement Wants. In one embodiment the concept Matching may refer to associating a new Wish with a Subject or a Want Association. A Need 910 may refer to an abstract representation of a problem people have, e.g., “I need to be able to easily carry lots of stuff with me”. A Want 907 may refer to an abstract representation of a solution to a problem, e.g., “I want a bag I wear on my back that can hold a lot of stuff”. In one embodiment, and Entity-Want Association 906 may be defined as an association between a Want, a Need, and an Entity. In another embodiment, an association Category Want Association 906 may be defined as an association between a Want, a Need, and a Category.

In one embodiment static data may refer to data used for matching that's common to all Subjects, contexts, etc., like Concepts. In another embodiment, dynamic data may refer to data used for matching that's particular to the thing to be matched to, like Concept Structures on Wants. In yet another embodiment, Status may refer to the current state of something (Subject, Wish, Entity Want Association) in its “flow” and a status message may be a custom message chosen by the Entity Associate 909 for an Entity Want Association 906, to give Thinkers 901 more details about the status of their Wish 902.

In one embodiment a Request for More Information may be a message a Decision Maker sends to a Thinker in response to a Wish, for the purpose of clarifying what the Thinker meant. Such request may be intended to help the Decision Maker determine how to address the Thinker's Wish. In another embodiment, a Public Want may be a Want Association that the Decision Maker has marked as Completed, Infeasible, or Existing, AND has marked as “public”. In yet another embodiment, an Actionable Solution may refer to a plan of action associated with an Entity Want Association, chosen by a Decision Maker. In a further embodiment, a Human Need 911 may refer to a fundamental human need, like “convenience” or “connectedness” (think like the layers of Maslow's hierarchy of needs, except more). A Need may always support at least one Human Need. In yet a further embodiment, a Wanted Solution (e.g., open/close tailgate button on keychain) may be an applied solution to a tangible Need (e.g., open tailgate remotely) that may indicate the Thinker values a given Human Need (e.g., convenience, a human need at the “human nature” abstraction level+car->automation a human need at a “good and services” level). In another further embodiment, the Human Need may be represented as a table which may contain both Generic Human Needs, as well as Category Level Human Needs. A Category Level Human Need may support at least one Generic Human Need (e.g. Car->Automation supports Convenience).

In one embodiment, an Insight 912 may be a knowledge production inferred from the systems knowledge base, as more ideas are submitted to the UIC system more additional knowledge/insights may be inferred by the system. In another embodiment Staff 905 may refer to Data Sorter which are staff who may take new Wishes that the matching algorithms couldn't match with an existing Subject, Want, or Need, then match them with the right Subject, Want, and Need, or that one or more of those may have to be created by Data Curators. In another embodiment Staff 905 may also refer to Data Curators which may be staff who define new Wants, Needs, and Subjects as we get Wishes concerning them.

In one embodiment elements of the data model may be associated to one or more statuses. For example, Subjects may have a status of Pending Claim Review, Not Interested, In Sales Process, and Waitlisted, Waiting for Information, No Contact, Active, and No Longer Active. A Wish may have the a Pending status, because of Subject Review Queue, Wish Review Queue, Spam Review Queue, Subject Creation Queue, Wish Creation Queue, Mismatch Review Queue and the like, another status may be Matched which means the Wish was matched to a Want. A wish may also have a Spam status if it is marked as Spam in a system process and may also have a Retracted status if it is deleted by the authored Thinker.

In one embodiment, Entity Want Associations may have a New status which means the association hasn't yet been looked at by a Decision Maker, and may just arrived in their queue, an Observed status which may indicates that in some way, a decision maker has “seen” the association, an Existing status which may indicate the Entity has already implemented the Want prior to the Entity joining the UIC system, an Existing (WW) status which may indicate that a Data Curator has indicated that an Entity has already implemented the Want, an Infeasible status which may indicate an entity will not implement the Want (commentary may provide rationale, e.g. not economical, etc.), Alternate Solution Preferred status which may indicate that a Decision Maker may have selected optionally another Want Association for this entity for same need, to specify that this is what has been selected as the solution to that need, an Accepted status which indicates an Entity plans to implement the Want eventually, and In Progress status which indicates an Entity is implementing the Want now (actual work is in progress), and a Completed status which indicates an Entity has implemented the Want. In one embodiment, Entity Want Associations may only be made public if they're Existing, Infeasible, or Completed. In one embodiment Category Want Association may have the statuses of Read, Partially Completed and a to be determined TBD status.

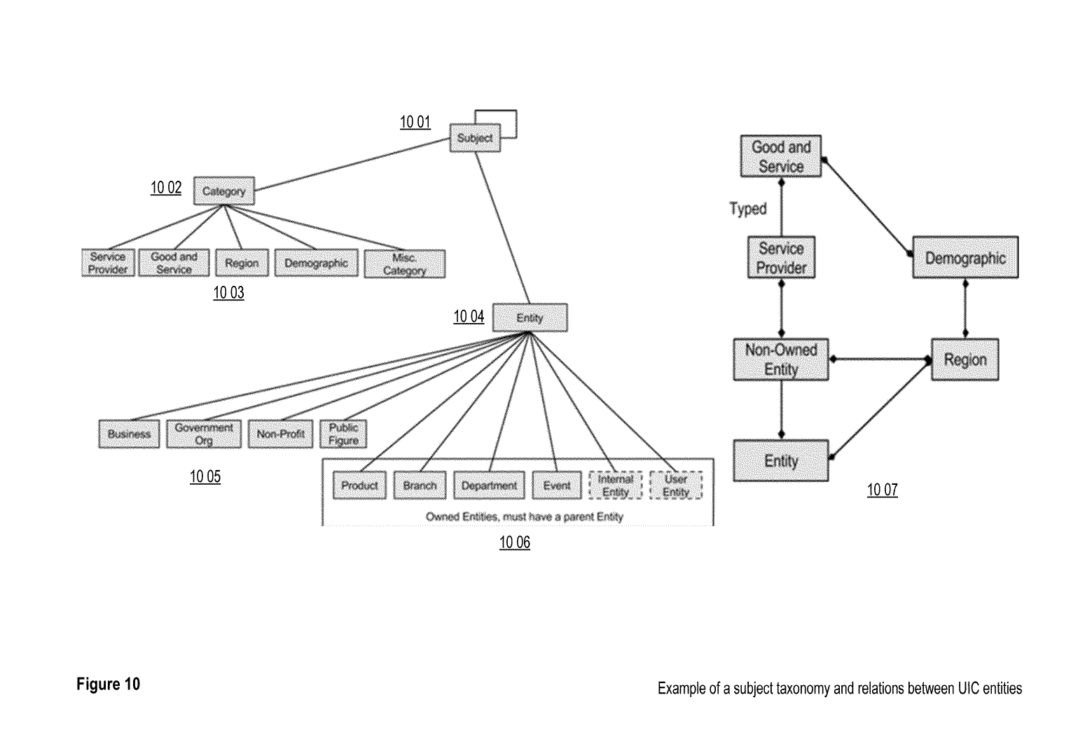

FIG. 10 shows an example of the taxonomy of a Subject model and relations between UIC entities, in one implementation of the UIC operation. In one embodiment a Subject model, e.g., 1001, may be a directed acyclic graph containing every registered Subject as vertices and ownership relations as edges. Subjects may be researched and created after they've received some Wishes or gotten a specific Subject or Entity creation request from a Decision Maker or Entity Associates. In another embodiment, Subjects may be represented as abstract entities, e.g., 1005, master entities, e.g., 1004 and or owned entities, e.g., 1006. In yet another embodiment, subjects may belong to one or more categories, e.g., 1002, depending on their characteristics for example demographic information, region of operation, provided services, provided goods and the like categories, e.g., 1003. In a further embodiment, the one or more categories to which a subject belongs may be interrelated in a plurality of ways. For example, a subject that is a master entity or non-owned entity may own a plurality of other entities, located at a plurality of regions, with more than one demographic, such entity may be a service provider of one or more services and/or goods e.g., 1007.

In one embodiment, a Subject-to-Subject Proximity Index may be implemented for quickly retrieving the Subjects related to any given Subject. Such index may be used for finding Want Association matches if a Wish is sent to a slightly wrong Subject (e.g. “I wish New York City would put more art in the subway stations” when the Subject with this Want Association is actually the NYC MTA, a child of New York City), and may also be used for suggesting Subjects for new Want Associations to Data Curators. Such index may be created for each Subject by performing a breadth-first search on the Subject model from that Subject, up to a certain distance according to what's most useful based on the current state of the Subject Graph and the matching algorithm.

In one embodiment a Subject Concept Index may be implemented. A Subject Concept Index may be implemented as a list of the Concepts used in any of a Subject's Want Associations, and their neighbors in their Concept-to-Concept Proximity Indices, such index may be kept cached for each Subject. Such index may be used to determine which concepts belong in the context of an incoming Wish, based on the Subject it was sent to. In another embodiment a Wish Concept Structure may be implemented. A Wish Concept Structure may be implemented as a collection of Concept Groups put into “buckets” that could describe a Want or Need. Each bucket may have one or more Concept Groups that describes it for each Want or Need. The Concept Structure of a Want Association may be the Concept Structures of its Want and Need concatenated. In yet another embodiment, Need and Want Concept Structures may be implemented. Need and Want Concept Structures may be implemented as collections of Concepts that describe a Want or Need. Want Associations may have a composite Concept Structure. Wants may have an action, an object of desire, context information, and “other details”. Actions may have one Concept, either “add”; “change”, or “remove”; the other concept groups may have any number of Concepts, though the object of desire may have at least one Concept. Each concept may have its own weighting in how important it is to a Want. Needs may not be referenced at all in a Wish, and may be referenced with just one or two words in a Wish, with any part-of-speech (adjective like “fast”, noun like “convenience”, verb like “meet”, etc.) in any part of the Wish. In a further embodiment, Needs and Wants may have a collection of Categories, e.g., 1002, 1003, they're relevant to. Want Associations may associate a Need, a Want, and a particular Subject, and a Wish sent to a low-level or owned Subject, e.g., 1006, may count toward the total Wishes sent to every Want Association for every Subject up to the highest-level Subject or Entity, e.g., 1004, for the Want Association's Want and Need (e.g. a Wish sent to “iPhone 5” could also count for “iPhone” and “Apple” and “smartphones”).

In one embodiment a Concept Graph may be implemented. A Concept Graph may be implemented as a graph of Concepts and their relations to each other. These relations may be universal, language-agnostic, directed, and typed. Such a Concept Graph may exist in database, and may be used for updates. Changes may trigger rebuilding Concept to Concept Indices for nearby Concepts. In another embodiment, the concept relationships may be typed. Types may be: Entailment/made-of. E.g. a subway platform implies a turnstile, or a house contains a door and walls. Generalization, E.g. a dog is a generalization of a bulldog, and a bulldog is a specialization of a dog. Parent/lifecycle. E.g. an adult is a “parent” of a child. Colocation. Blue collocates with Sky.

In one embodiment, Symbol-to-Concept Associations may be implemented. A Symbol-to-Concept Association may be implemented as an association of objects that link Symbols (strings) to Concepts. Such association may also include the Locale (e.g. “EN-US” for American English). In another embodiment, a Concept-to-Concept Proximity Index (CCPI) may be implemented for matching purposes, such index may reside in-memory and may kept sorted, refreshed over time as changes to the underlying model (i.e. the Concept Graph) are applied. The CCPI may be built as Concept1, Concept2, ProximityScore. In yet another embodiment the Proximity Score may be calculated on the basis of distance (number of hops) and relationship type and strength. The Distance score may be calculated as direct edge as 3, and 1 for each hop. The Relationship score may be calculated as relationship strength (1 to 3) multiplied by a relationship type score: colocation: 1 contains: 2, lifecycle: 3 and generalization: 4. The Relationship type scores and strengths may be parameters that can be varied to find the best matching.

FIG. 11 shows an example of ideas decomposition and insights production, in one implementation of the UIC operation. In one embodiment, the UIC may utilize language processing technology to match similar wishes and produce insights from a set of collected wishes. For example, a Thinker may submit, e.g., 1101, the following idea: I wish Ford F-150 would add a key chain button to control the tailgate so I can open it remotely. Such idea may be decomposed in the following parts: Person (e.g., 1105): I, Subject (e.g., 1102): Ford F-150, Want (e.g., 1104): add a key chain button to control the tail gate and Need (e.g., 1103): I can open it remotely. From the Thinkers profile the following information may be gathered: The person is a customer (i.e., Role 1106) and a male baby boomer (i.e., Persona 1110). Through an analysis of the need Human Needs (e.g., 1107) may be inferred for example it can be inferred that the Thinker values may be Convenience, and Car Automations and this may be interpreted as a human need. In another embodiment, the wish may also be applied to all Trucks (i.e., Goods and Services 1108) and to the Automotive Industry (i.e., Service Providers 1109). In yet another embodiment a plurality of wishes along with the additional information that can be gathered from their structure are stored in a knowledge base e.g., 1012. In yet another embodiment, information stored in the knowledge base may be retrieve to be fed into an inference engine 1113 to produce one or more Insights 1111 e.g., Baby Boomers now love technology.

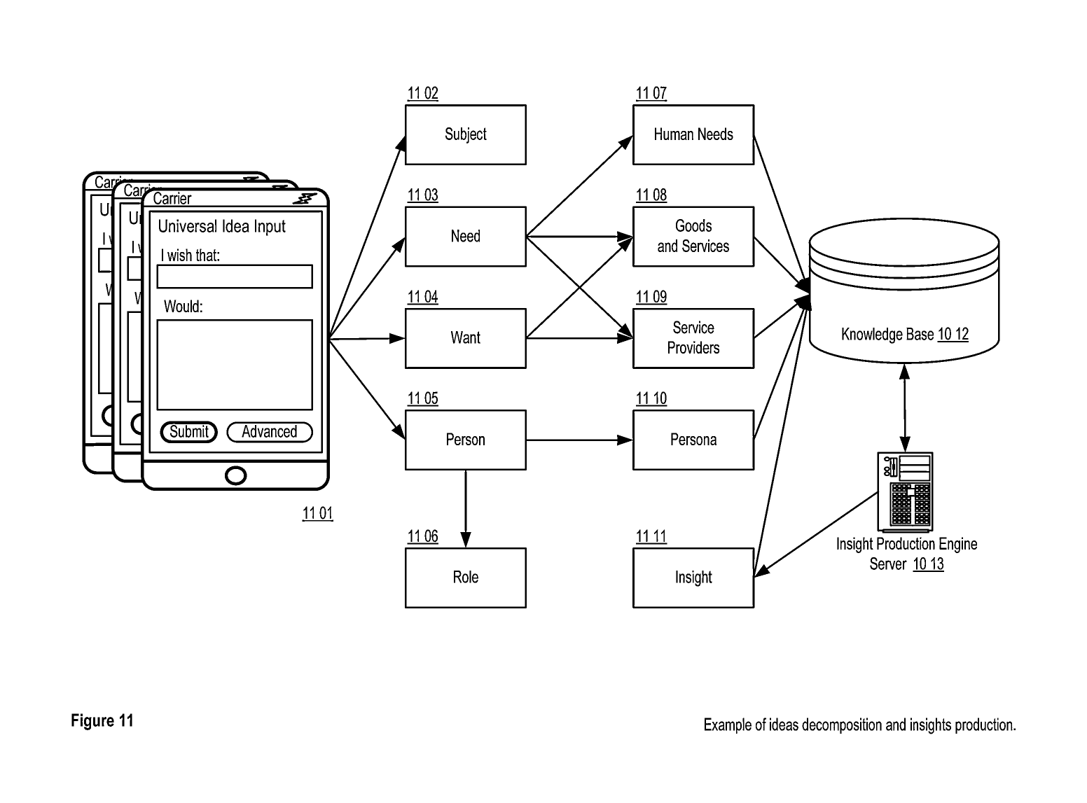

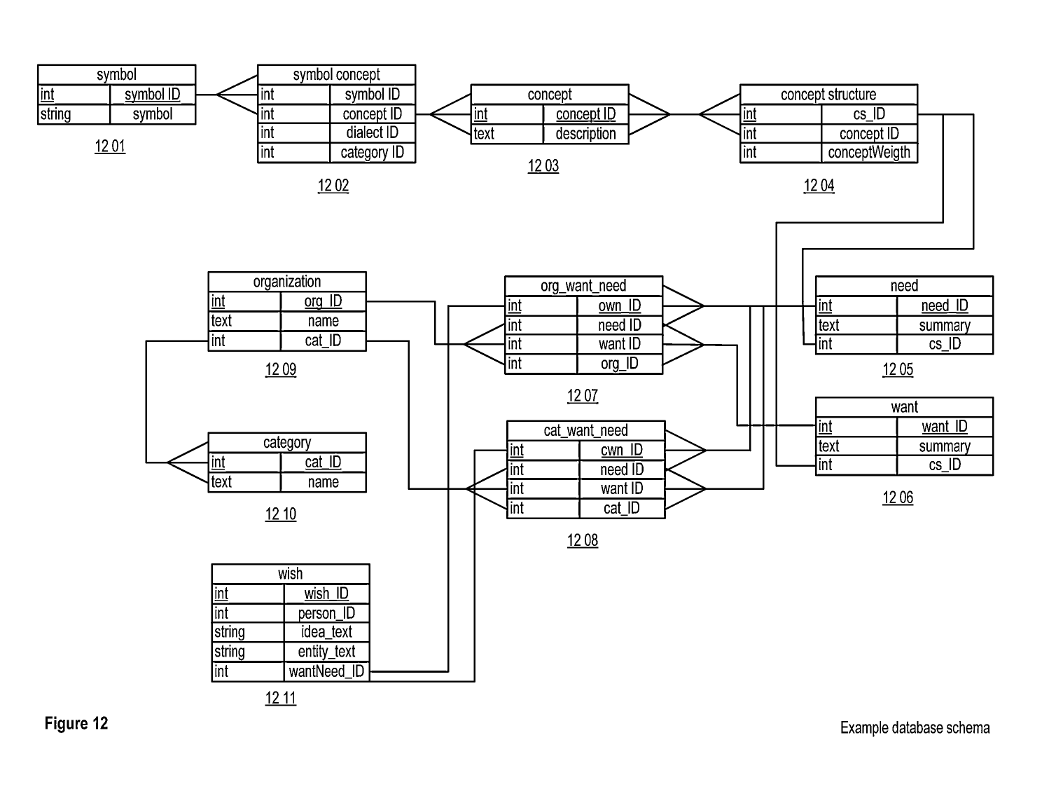

FIG. 12 shows an example database schema, in one implementation of the UIC operation. In one embodiment the database comprises a Symbol table 1201 which is related to a Symbol Concept table 1202 by a one to many relationship. In another embodiment, the Symbol Concept table is related to a Concept table 1203 by a one to many relationship. In yet another embodiment, the Concept table is related to the Concept Structure table 1204 by a many to many relationship.

In one embodiment, the Concept Structure table is related to a Need table 1205 by a one to one relationship. In another embodiment the Concept Structure table is related to a Want table 1206 by a one to one relationship. In yet another embodiment the Need table is related to an Org_Want_Need table 1207 by a one to many relationship. In a further embodiment the Need table is related to the Cat_Want_Need table 1208 by two one to many relationships. In yet a further embodiment, the Want table is related to the Org_Want_Need table by a one to many relationship.

In one embodiment the Org_Want_Need table is related to a Wish table 1211 by a one to one relationship. In another embodiment the Org_Want_Need table is related to an Organization table 1209 by a many to one relationship. In yet another embodiment the Cat_Want_Need table may be related to the Wish table by a one to one relationship. In a further embodiment, the Cat_Want_Need table may be related to the Organization table by a many to one relationship. In a yet further embodiment, the Organization table may be related to a Category table 1210 by a one to many relationship.

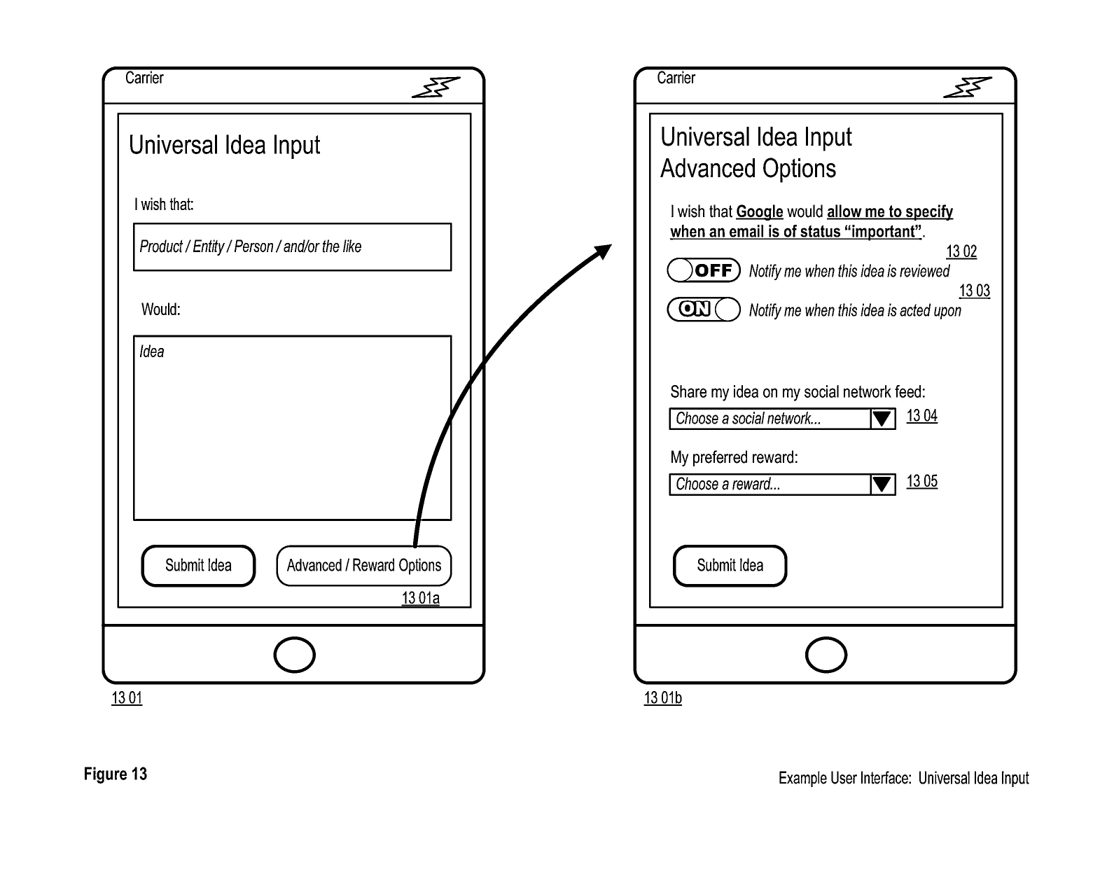

FIG. 13 shows an example user interface: universal idea input, in one implementation of the UIC operation. In one embodiment, a user mobile device 1301 may display a universal idea input interface. In one embodiment, a user may select to input advanced idea parameters, e.g., 1301a, and be directed to an advanced idea input interface 1301b. In one embodiment, the user may request to be notified when their idea is reviewed, e.g., 1302, when their idea is acted upon, e.g. 1303, and/or the like. In a further embodiments, the user may share their idea on a social media feed, e.g., 1304, and select a preferred reward to be issued, e.g., 1305, for example, if the user's idea is implemented.

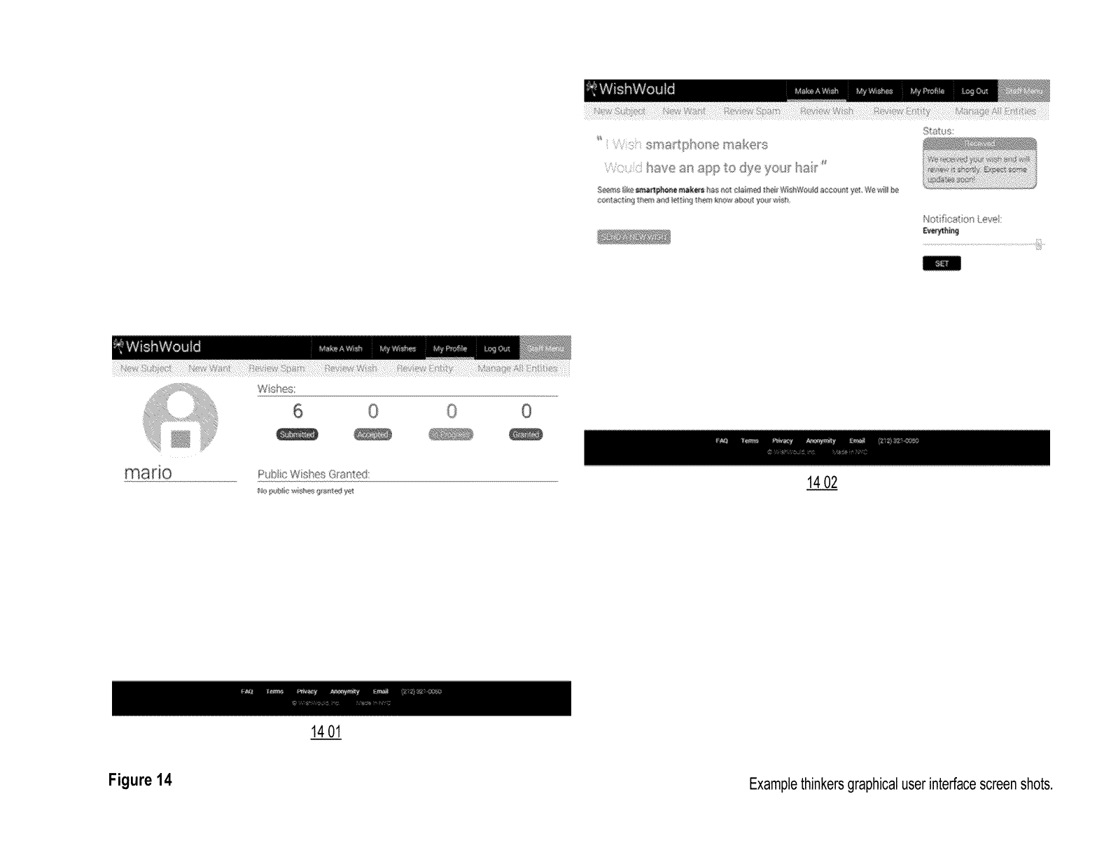

FIG. 14 shows an example of thinkers' graphical user interface screen shots, in one implementation of the UIC operation. In one embodiment a Thinker may have the option to interact with a plurality of graphical user interfaces including but not limited to an interface to submit a wish or idea, an interface with a dashboard showing statistics and statuses of submitted wishes e.g., 1401, an interface where Thinkers may view information related to an specific wish e.g., 1402, an interface where a Thinker may enter or edit profile data, and/or the like Thinker interfaces.

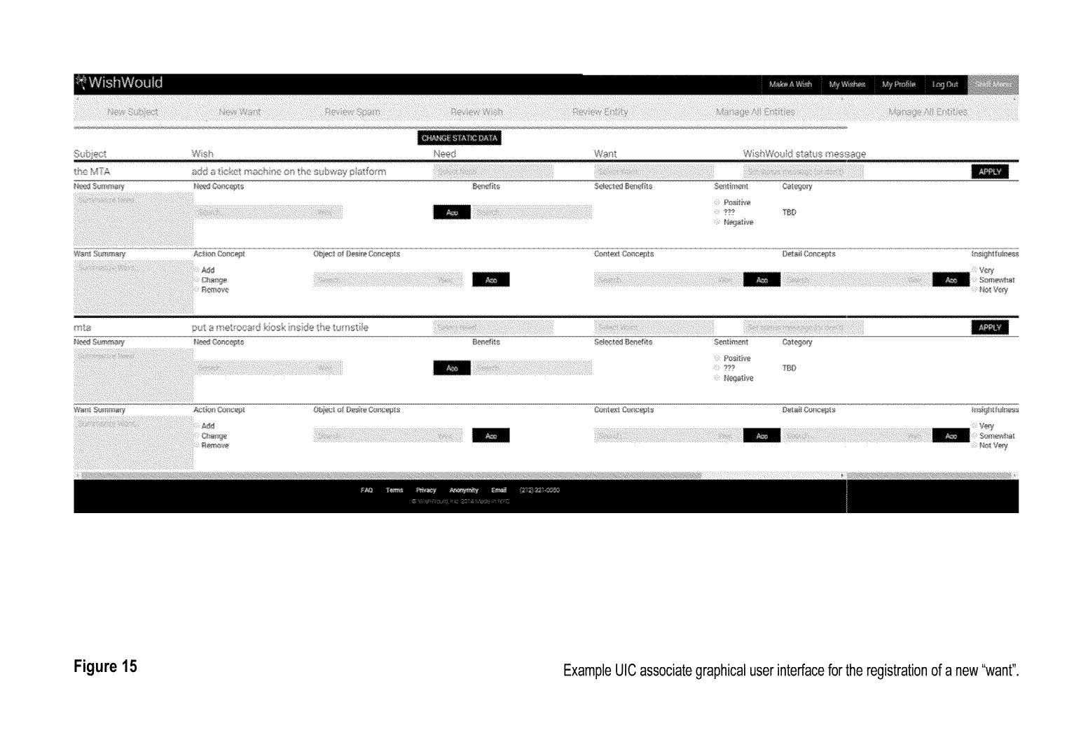

FIG. 15 shows an example of UIC associate graphical user interface for the registration of a new “Want”, in one implementation of the UIC operation. In one embodiment a UIC associate may register a new Want for a Subject through a graphical user interface. The graphical user interface may comprise a plurality of fields the may be entered with Want related information including but not limited to a subject, wish, need, want, status, human need, need summary, need concepts, sentiments, category and the like fields.

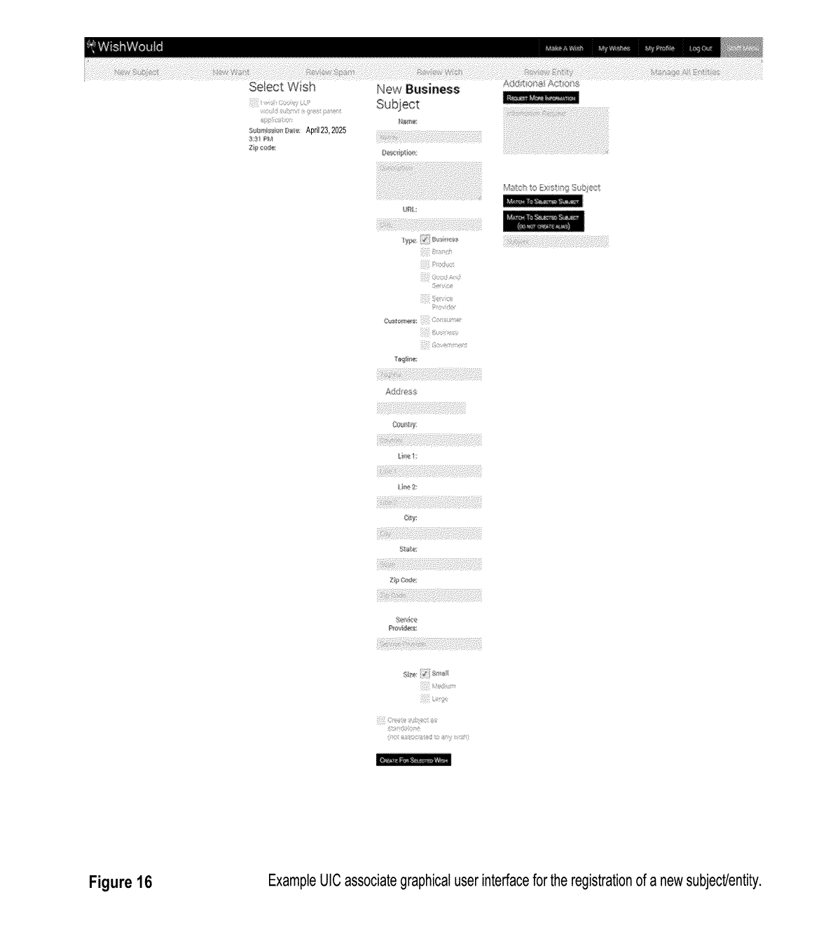

FIG. 16 shows an example UIC associate graphical user interface for the registration of a new subject/entity, in one implementation of the UIC operation. In one embodiment, a UIC associate may register a new subject/entity through a graphical user interface comprising a plurality of fields that may be entered with subject/entity related information including but not limited to name, description, URL, subject type, customers demographics, address, service providers, size and the like. In another embodiment, a UIC associate may be provided with additional interfaces to perform UIC related operations including but not limited to review spam, review wish, review an entity or subject, manage all entities/subjects and the like interfaces.

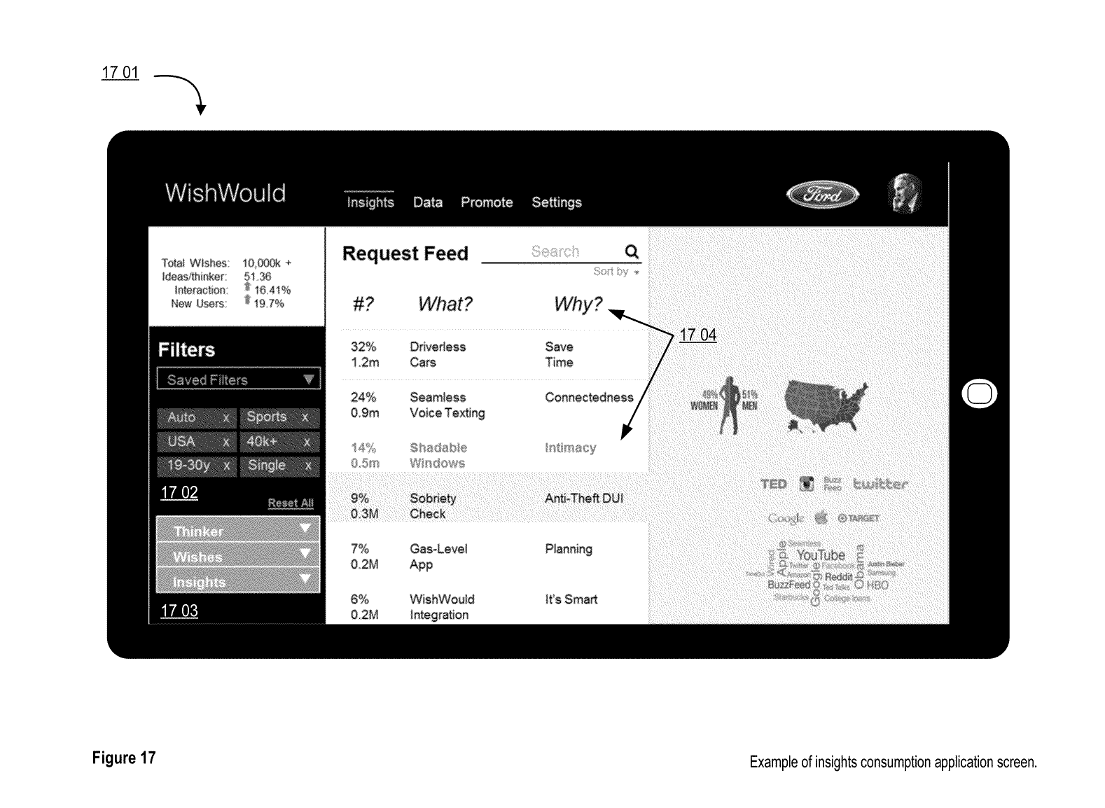

FIG. 17 shows an example of insights consumption application screen shot, e.g., 1701, in one implementation of the UIC operation. In one embodiment insights may be filtered according to a consumer interests e.g., 1702. In another embodiment, specific information regarding Thinkers, Wishes or Insights may be selected for display e.g., 1703. In yet another embodiment, the selected information may be displayed sorted and organized on a table and/or graphical forms according to consumers selected configurations e.g., 1704.

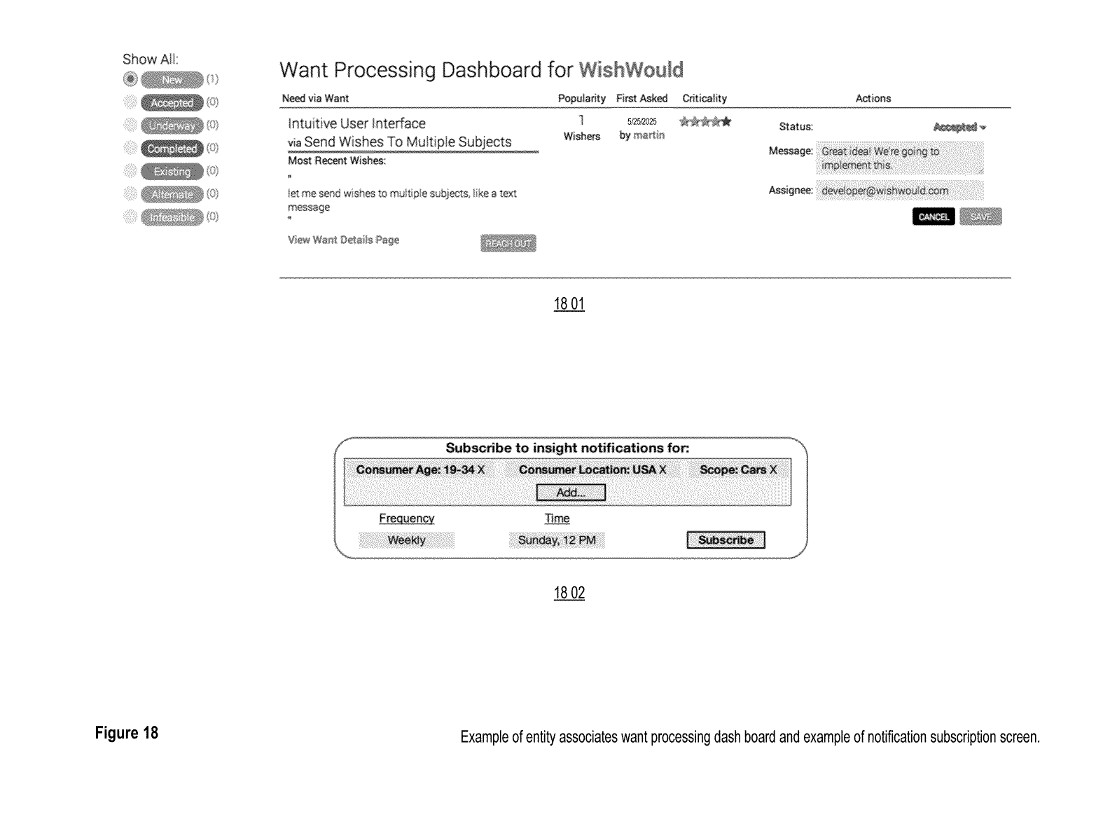

FIG. 18 shows an example of entity associates want processing dash board and example of notification subscription screen, in one implementation of the UIC operation. In one embodiment, the UIC system may provide a graphical user interface for entity or subject associates to process received Thinkers' Wants e.g., 1801. In one embodiment, the associate may choose to view Wants which may be organized in a plurality of categories including but not limited to New, Accepted, Underway, Completed, Existing, Alternate, Infeasible and/or the like. Other mechanisms included in the graphical user interface may allow the associate to learn details about specific Wants such as the number of Thinkers endorsing a Want i.e., popularity, the Want status, and/or the like information. In another embodiment, Entity Associates select Statuses and enter Messages for Need Want Associations, triggering notifications for Thinkers.

In one embodiment, an entity associate may subscribe to receive periodic information regarding a specified dimension for example, a consumer age group, from a specific location and/or related to a type of products e.g., 1802.

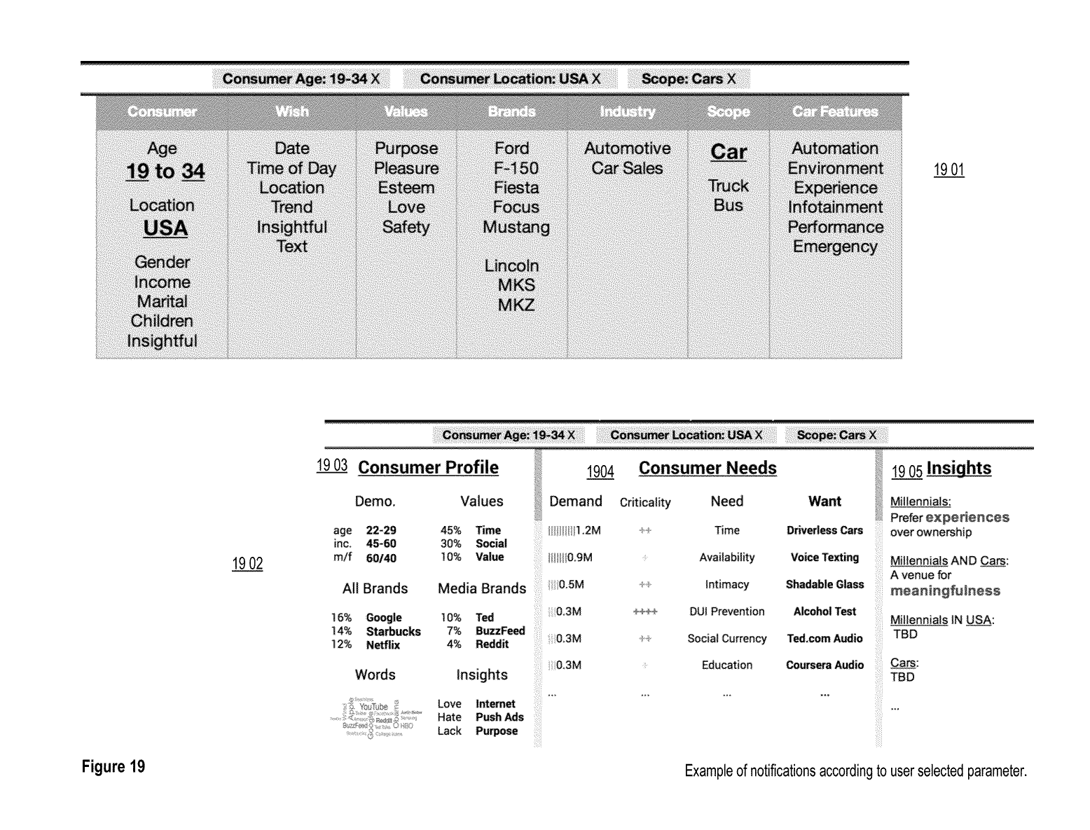

FIG. 19 shows an example of notifications according to user selected parameter, in one implementation of the UIC operation, in one implementation of the UIC operation. In one embodiment, entity associates may retrieve information by entering demographic information such as consumers age e.g., 19-34, consumers location e.g., USA and scope e.g., Cars. The retrieved information may include but not be limited to information regarding consumers, wishes, values, brands, industry, scope, and product features e.g., 1901. In another embodiment, a different type of criteria may be chosen to configure the notification subscription form. A screen shot showing the information that may be included in an example notification is shown in 1902 wherein the information may comprise a plurality of insight types including but not limited to consumer profiles e.g., 1903 including but not limited to demographics, values, brands, media brands, key words, and other insights, consumer needs e.g., 1904 including but not limited to demand, criticality, need want associations, insights/millennials e.g 1905 and the like. In one embodiment, criticality may be a function on how much notification thinkers may want to receive with respect to a need want association. For example, if the majority of thinkers that had expressed a common need want association had also expressed that they want to be notified of anything related to the implementation of a solution for the common need want association then, said need want association may be marked as highly critical. Insights, when considered at higher levels, may be known as high-level insights. Similarly, high-level insights, when decomposed into their constituent parts, may contain a multiplicity of included insights. As used herein, the terms insights and high-level insights may be used to refer to insights in an aggregated form, a decomposed form, and/or the like.

Other embodiments of the present invention may include a Thinker Profile e.g., a profile page detailing the key stats of a Thinker. Which may be public or private, a Subject Profile e.g., a profile page giving stats and info about a Subject, a Subject Want Detail Page e.g., a page giving details about a specific want as it relates to a Subject (i.e. via a Want Association), a Subject Forum e.g., a section on a Subject profile that displays the comments between fans of this Subject, Online Analytical Processing e.g., computer processing that enables a user to easily and selectively extract and view data from different points of view, an Influencer Score e.g., a score that's calculated for each Thinker if they link their account to any social media. This score may be a function of the number of followers they have, the frequency with which they share things and the average Insightfulness Score for the Thinker's Wishes, Entity Want Association Cost and Benefits e.g., each Entity Want Association may have a Cost and a Benefit associated with it. The Cost expressed as an integer between 1 and 10, and the Benefit may be defined as (# wishes*avg. criticality per wisher*avg. influence score per wisher).

In another embodiment, the UIC system may produce integrated data for upstream marketing comprising demographic details for a consumer segment e.g. income, levels derived from set of wishes for entities tagged as expansive or not expansive, pricing point for product given income level estimates, the most demanded brands that consumers love as derived from the number of wishes sent to those brands (e.g., Google, Starbucks, Netflix), the most demanded brand “that are media brands” (similar to above, but for things that may be media/ads), words used by consumers via analyzing symbols used by a corresponding consumer group, word mesh, key insights for a consumer profile (e.g. lack sense of purpose), High-Level Insights associated with the “dimensions” that were selected in a filtered query and or the like integrated data.

### UIC Controller

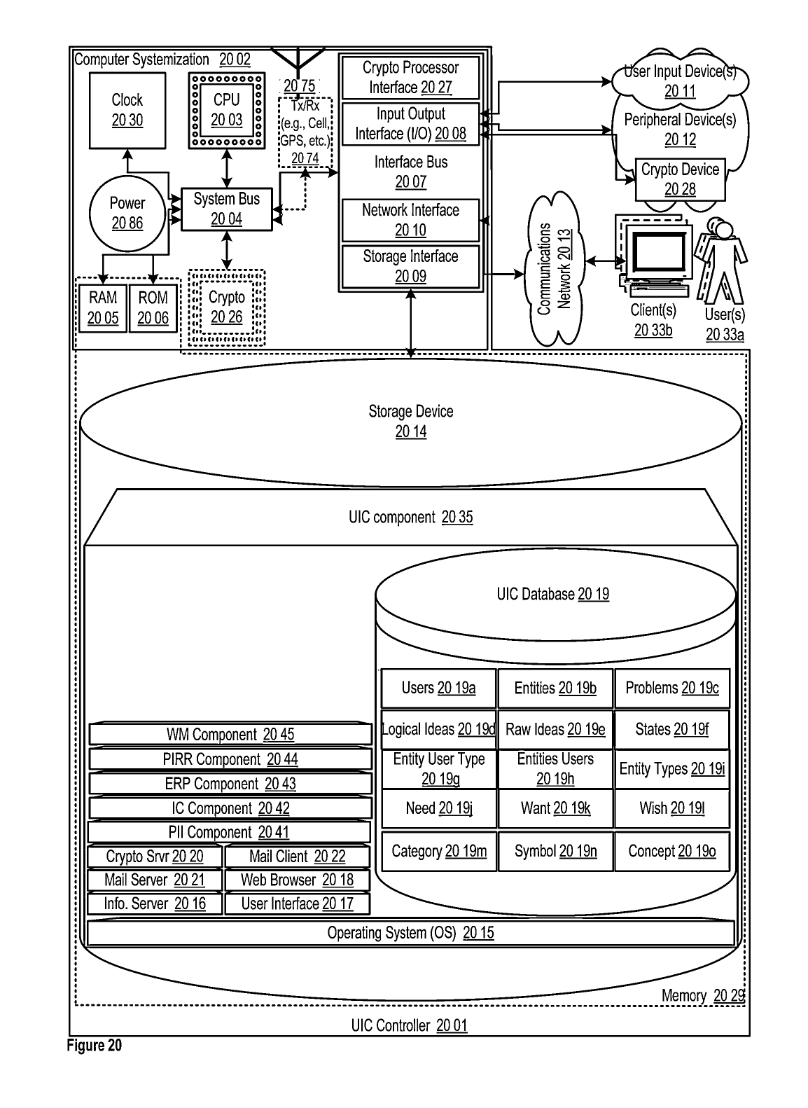

FIG. 20 shows a block diagram illustrating embodiments of a UIC controller. In this embodiment, the UIC controller 2001 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 2003 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2029 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the UIC controller 2001 may be connected to and/or communicate with entities such as, but not limited to: one or more users from user input devices 2011; peripheral devices 2012; an optional cryptographic processor device 2028; and/or a communications network 2013.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The UIC controller 2001 may be based on computer systems that may comprise, but are not limited to, components such as: a computer systemization 2002 connected to memory 2029.

### Computer Systemization

A computer systemization 2002 may comprise a clock 2030, central processing unit (“CPU(s)” and/or “processor(s)” (these terms are used interchangeable throughout the disclosure unless noted to the contrary)) 2003, a memory 2029 (e.g., a read only memory (ROM) 2006, a random access memory (RAM) 2005, etc.), and/or an interface bus 2007, and most frequently, although not necessarily, are all interconnected and/or communicating through a system bus 2004 on one or more (mother)board(s) 2002 having conductive and/or otherwise transportive circuit pathways through which instructions (e.g., binary encoded signals) may travel to effectuate communications, operations, storage, etc. The computer systemization may be connected to a power source 2086; e.g., optionally the power source may be internal. Optionally, a cryptographic processor 2026 and/or transceivers (e.g., ICs) 2074 may be connected to the system bus. In another embodiment, the cryptographic processor and/or transceivers may be connected as either internal and/or external peripheral devices 2012 via the interface bus I/O. In turn, the transceivers may be connected to antenna(s) 2075, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing UIC controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 2029 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the UIC controller and beyond through various interfaces. Should processing requirements dictate a greater amount speed and/or capacity, distributed processors (e.g., Distributed UIC), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the UIC may be achieved by implementing a microcontroller such as CAST's R8051XC2 microcontroller; Intel's MCS 51 (i.e., 8051 microcontroller); and/or the like. Also, to implement certain features of the UIC, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the UIC component collection (distributed or otherwise) and/or features may be implemented via the microprocessor and/or via embedded components; e.g., via ASIC, coprocessor, DSP, FPGA, and/or the like. Alternately, some implementations of the UIC may be implemented with embedded components that are configured and used to achieve a variety of features or signal processing.

Depending on the particular implementation, the embedded components may include software solutions, hardware solutions, and/or some combination of both hardware/software solutions. For example, UIC features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the UIC features. A hierarchy of programmable interconnects allow logic blocks to be interconnected as needed by the UIC system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the UIC may be developed on regular FPGAs and then migrated into a fixed version that more resembles ASIC implementations. Alternate or coordinating implementations may migrate UIC controller features to a final ASIC instead of or in addition to FPGAs. Depending on the implementation all of the aforementioned embedded components and microprocessors may be considered the “CPU” and/or “processor” for the UIC.

### Power Source

The power source 2086 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2086 is connected to at least one of the interconnected subsequent components of the UIC thereby providing an electric current to all subsequent components. In one example, the power source 2086 is connected to the system bus component 2004. In an alternative embodiment, an outside power source 2086 is provided through a connection across the I/O 2008 interface. For example, a USB and/or IEEE 1394 connection carries both data and power across the connection and is therefore a suitable source of power.

### Interface Adapters

Interface bus(ses) 2007 may accept, connect, and/or communicate to a number of interface adapters, conventionally although not necessarily in the form of adapter cards, such as but not limited to: input output interfaces (I/O) 2008, storage interfaces 2009, network interfaces 2010, and/or the like. Optionally, cryptographic processor interfaces 2027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2009 may accept, communicate, and/or connect to a number of storage devices such as, but not limited to: storage devices 2014, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2010 may accept, communicate, and/or connect to a communications network 2013. Through a communications network 2013, the UIC controller is accessible through remote clients 2033b (e.g., computers with web browsers) by users 2033a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed UIC), architectures may similarly be employed to pool, load balance, and/or otherwise increase the communicative bandwidth required by the UIC controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2010 may be used to engage with various communications network types 2013. For example, multiple network interfaces may be employed to allow for the communication over broadcast, multicast, and/or unicast networks.

Input Output interfaces (I/O) 2008 may accept, communicate, and/or connect to user input devices 2011, peripheral devices 2012, cryptographic processor devices 2028, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 2011 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 2012 may be connected and/or communicate to I/O and/or other facilities of the like such as network interfaces, storage interfaces, directly to the interface bus, system bus, the CPU, and/or the like. Peripheral devices may be external, internal and/or part of the UIC controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the UIC controller may be embodied as an embedded, dedicated, and/or monitor-less (i.e., headless) device, wherein access would be provided over a network interface connection.

Cryptographic units such as, but not limited to, microcontrollers, processors 2026, interfaces 2027, and/or devices 2028 may be attached, and/or communicate with the UIC controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2029. However, memory is a fungible technology and resource, thus, any number of memory embodiments may be employed in lieu of or in concert with one another. It is to be understood that the UIC controller and/or a computer systemization may employ various forms of memory 2029. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 2029 will include ROM 2006, RAM 2005, and a storage device 2014. A storage device 2014 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 2029 may contain a collection of program and/or database components and/or data such as, but not limited to: operating system component(s) 2015 (operating system); information server component(s) 2016 (information server); user interface component(s) 2017 (user interface); Web browser component(s) 2018 (Web browser); database(s) 2019; mail server component(s) 2021; mail client component(s) 2022; cryptographic server component(s) 2020 (cryptographic server); the UIC component(s) 2035; PII Component 2041, IC Component 2042, ERP Component 2043, PIRR Component 2044, WM Component 2045; and/or the like (i.e., collectively a component collection). These components may be stored and accessed from the storage devices and/or from storage devices accessible through an interface bus. Although non-conventional program components such as those in the component collection, typically, are stored in a local storage device 2014, they may also be loaded and/or stored in memory such as: peripheral devices, RAM, remote storage facilities through a communications network, ROM, various forms of memory, and/or the like.

### Operating System

The operating system component 2015 is an executable program component facilitating the operation of the UIC controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP/Win7 (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the UIC controller to communicate with other entities through a communications network 2013. Various communication protocols may be used by the UIC controller as a subcarrier transport mechanism for interaction, such as, but not limited to: multicast, TCP/IP, UDP, unicast, and/or the like.

### Information Server

An information server component 2016 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the UIC controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the UIC database 2019, operating systems, other program components, user interfaces, Web browsers, and/or the like.

Access to the UIC database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the UIC. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the UIC as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery UI, MooTools, Prototype, script.aculo.us, SWFObject, Yahoo! User Interface, any of which may be used and provide a baseline and means of accessing and displaying information graphically to users.

A user interface component 2017 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2018 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Firefox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the UIC enabled nodes. The combined application may be nugatory on systems employing standard Web browsers.

### Mail Server

A mail server component 2021 is a stored program component that is executed by a CPU 2003. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the UIC.

Access to the UIC mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2022 is a stored program component that is executed by a CPU 2003. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 2020 is a stored program component that is executed by a CPU 2003, cryptographic processor 2026, cryptographic processor interface 2027, cryptographic processor device 2028, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the UIC may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the UIC component to engage in secure transactions if so desired. The cryptographic component facilitates the secure accessing of resources on the UIC and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The UIC Database

The UIC database component 2019 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the UIC database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the UIC database is implemented as a data-structure, the use of the UIC database 2019 may be integrated into another component such as the UIC component 2035. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2019 includes several tables 2019a-o. A Users table 2019a may include fields such as, but not limited to: user_id, encrypted_password, reset_password_token, reset_password_sent_at, remember_created_at, sign in_count, current_sign_in_at, last_sign_in_at, confirmed_at, confirmation_sent_at, unconfirmed_email, name, email, and/or the like. The Users table may support and/or track multiple entity accounts on a UIC. An Entities table 2019b may include fields such as, but not limited to: entity_id, entity_type_id, name, user_id, parent_entity_id, localized, location, and/or the like. A Problems table 2019c may include fields such as, but not limited to: id, user_id, entity_id, description, created_at, and/or the like. An Ideas table 2019d may include fields such as, but not limited to: id, user_id, entity_id, description, problem_id, created_at, and/or the like. A Raw Ideas table 2019e may include fields such as, but not limited to: id, user_id, entity_name, description, logical_idea_id, state_id, created_at, and/or the like. A States table 2019f may include fields such as, but not limited to: id, name, code, and/or the like. An Entity_User_Type table 2019g may include fields such as, but not limited to: id, name, code, entity_id, and/or the like. An Entity_Users table 2019h may include fields such as, but not limited to: entity_id, user_id, entity_user_type_id, and/or the like. An Entity_Types table 2019i may include fields such as, but not limited to: id, name, code, entity_type_code, industry_code, and/or the like. A Needs table 2019j may include fields such as, but not limited to: need_id, summary, cs_id, and/or the like. A Want table 2019k may include fields such as, but not limited to: want_id, summary, cs_id, and/or the like. A Wish table 2019l may include fields such as, but not limited to: wish_id, person_id, idea_text, entity_text, wantNeed_id, and/or the like. A Category table 2019m may include fields such as, but not limited to: cat_id, name, and/or the like. A Symbol table 2019n may include fields such as, but not limited to: symbol_id, symbol, and/or the like. A Concept table 2019o may include fields such as, but not limited to: concept_id, description, and/or the like.

In one embodiment, the UIC database may interact with other database systems. For example, employing a distributed database system, queries and data access by search UIC component may treat the combination of the UIC database, an integrated data security layer database as a single database entity.

In one embodiment, user programs may contain various user interface primitives, which may serve to update the UIC. Also, various accounts may require custom database tables depending upon the environments and the types of clients the UIC may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2019a-o. The UIC may be configured to keep track of various settings, inputs, and parameters via database controllers.

The UIC database may communicate to and/or with other components in a component collection, including itself, and/or facilities of the like. Most frequently, the UIC database communicates with the UIC component, other program components, and/or the like. The database may contain, retain, and provide information regarding other nodes and data.

### The UICs

The UIC component 2035 is a stored program component that is executed by a CPU. In one embodiment, the UIC component incorporates any and/or all combinations of the aspects of the UIC that was discussed in the previous figures. As such, the UIC affects accessing, obtaining and the provision of information, services, transactions, and/or the like across various communications networks. The features and embodiments of the UIC discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the UIC's features and facilities, and in many cases reduce the costs, energy consumption/requirements, and extend the life of UIC's underlying infrastructure; this has the added benefit of making the UIC more reliable. Similarly, many of the features and mechanisms are designed to be easier for users to use and access, thereby broadening the audience that may enjoy/employ and exploit the feature sets of the UIC; such ease of use also helps to increase the reliability of the UIC. In addition, the feature sets include heightened security as noted via the Cryptographic components 2020, 2026, 2028 and throughout, making access to the features and data more reliable and secure.

The UIC component may transform ideas into an organized model of subjects and consumable insights, and/or the like and use the UIC. In one embodiment, the UIC component 2035 takes inputs (e.g., User Idea Input Request 205, Idea Input 204, Idea Clarification 208, Idea Clarification Response 209, Idea Input 302, User Idea Input Request 303, Evaluate Need Want Association 307, New Need Want Association Review Response 308, Need Want Corroboration Request 305, and/or the like) etc., and transforms the inputs via various components (e.g., PII Component 2041, IC Component 2042, ERP Component 2043, PIRR Component 2044, WM Component 2045 and/or the like), into outputs (e.g., Idea Clarification Request 207, Idea Matching Store Idea 210 and trigger update 212, User Idea Reward Notification 214, Request to review a Need Want association 306, Store need want association 310, store idea 313, Thinker idea reward, thinker score, notifications 316, Redeem reward card code, review scores and notifications 317 and/or the like).

The UIC component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the UIC server employs a cryptographic server to encrypt and decrypt communications. The UIC component may communicate to and/or with other components in a component collection, including itself, and/or facilities of the like. Most frequently, the UIC component communicates with the UIC database, operating systems, other program components, and/or the like. The UIC may contain, communicate, generate, obtain, and/or provide program component, system, user, and/or data communications, requests, and/or responses.

### Distributed UICs

The structure and/or operation of any of the UIC node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the UIC controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the UIC controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
//set ip address and port to listen to for incoming data
$address = ‘192.168.0.100’;
$port = 255;
//create a server-side SSL socket, listen
//for/accept incoming communication
$sock = socket_create(AF_INET, SOCK_STREAM, 0);
socket_bind($sock, $address, $port)
    or die(‘Could not bind to address’);
socket_listen($sock);
$client = socket_accept($sock);
//read input data from client device in 1024 byte
//blocks until end of message
do {
      $input = “”;
      $input = socket_read($client, 1024);
      $data .= $input;
} while($input != “”);
// parse data to extract variables
$obj = json_decode($data, true);
// store input data in a database
mysql_connect(″10.1.1.1″,$srvr,$pass); // access database server
mysql_select(″CLIENT_DB.SQL″); // select database to append
mysql_query(“INSERT INTO UserTable (transmission) VALUES
($data)”); // add data to UserTable table in a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?
topic=/com.ibm.IBMDI.doc/referenceguide295.htm

and other parser implementations:

http://publib.boulder.ibm.com/infocenter/tivihelp/v2r1/index.jsp?
topic=/com.ibm.IBMDI.doc/referenceguide259.htm

all of which are hereby expressly incorporated by reference.

Additional embodiments of the UIC may include:

1. A processor implemented method of user reward issuance, comprising:

issuing a plurality of unredeemed user rewards in response to a user idea input;

receiving a notification that the user has selected one of the plurality of unredeemed user rewards;

updating the status of the selected user reward to active; and

updating the status of the unselected rewards to unredeemable.

In order to address various issues and advance the art, the entirety of this application for UIC (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a UIC individual and/or enterprise user, database configuration and/or relational model, data type, data transmission and/or network framework, syntax structure, and/or the like, various embodiments of the UIC, may be implemented that enable a great deal of flexibility and customization. For example, aspects of the UIC may be adapted for restaurant dining, online shopping, brick-and-mortar shopping, secured information processing, and/or the like. While various embodiments and discussions of the UIC have been directed to electronic purchase transactions, however, it is to be understood that the embodiments described herein may be readily configured and/or customized for a wide variety of other applications and/or implementations.

What is claimed is:

1. A processor implemented method of converting user idea inputs into matching idea triggers, comprising:
receiving, by a processor, a user idea input request including at least a user-specified subject, a user-specified need to be satisfied and a user-specified wanted solution to satisfy said need;
determining, through the processor, a class to which the user-specified subject belongs and adding a node that is semantically equivalent to the user-specified subject to a directed acyclical graph under a graph section corresponding to the determined class only after verifying that there is no node under the corresponding class that is semantically equivalent to the user-specified subject residing in the graph already;
concatenating, through the processor, the user-specified need and the user-specified wanted solution to generate a need-want structure; and
determining, through the processor, a corresponding match to the generated need-want structure from a set of need want associations linked to the semantically equivalent node or linked to any node in a sequence that contains all the semantically equivalent node ancestors, starting with its immediate parent and ending with the root node and increasing a demand score associated with the need want structure if a corresponding match is found.

2. The processor implemented method of claim 1, further comprising:
sending a need want corroboration request to an idea receiver server associated with the semantically equivalent node if a corresponding match is not found;
adapting the need-want structure to conform to the format of a need-want association and link it to the semantically equivalent node only after receiving a positive need want corroboration response form the idea receiver server;
calculating a user insightfulness score; and
sending a message directed to the user who submitted the user idea input request comprising information about the submitted idea, information from the idea receiver and an insightfulness score.

3. The processor implemented method of claim 1, further comprising:
sending a message directed to the user who submitted the user idea input request comprising information about the submitted idea.

4. The processor implemented method of claim 2, further comprising the steps of:
receiving by the idea receiver server a new need want association review response;
categorizing a user-defined need want structure;
generating a message directed to the user who submitted the user idea input request;
storing the need want structure as a need want association in a local repository; and
sending a need want corroboration response comprising the generated message.

5. The processor implemented method of claim 4, wherein said categorization value of the user-defined need want structure is selected from the group comprising of spam, not an idea, duplicate type, more info request type, not feasible type, not strategic type, already live type, and new valid.

6. The processor implemented method of claim 2, further comprising:
sending periodic notifications to the user who submitted the user idea input request comprising idea statuses communicating at what stage the inputted idea is in an implementation process and current user insightfulness score;

7. The processor implemented method of claim 5, further comprising:
recording data related to a new subject added to the directed acyclic graph wherein said subject data is selected from the group of data comprising of type, revenue, profit, locations, number of employees, geographic markets, headquarter location, customer type, founded date, and default thinker role; and
recording data related to the user who has submitted the idea input request said user data is selected from the group of data comprising of date of birth, sex, gender, socioeconomic status, highest education level, nationality, country of residency, family members, and marital status.

8. The processor implemented method of claim 7, further comprising:
feeding a plurality of recorded data into an inference engine comprising at least one system generated dimension;
generating at least one insight with respect to at least one of the said comprising dimensions; and
saving at least one insight into a knowledge base associated to at least one of the said comprising dimensions.

9. The processor implemented method of claim 8, further comprising:
receiving a user request for at least one insight comprising at least one dimension; and
retrieving from a knowledge base at least one insight, related to at least one received dimension wherein the retrieved data comprises integrated data for upstream marketing;

10. A processor implemented method of determining a corresponding match for need want structures comprising:
decomposing a need-want structure into a list of tokens wherein each token represents a word in the structure;
generating a refined token list by removing any token representing a stopword and reducing tokens representing inflected or derived words to their corresponding stem;
generating a plurality of sets of representative symbols wherein a set of representative symbols is generated for each token in the refined token list and wherein the symbols are contextually relevant to a common subject;
generating an exhaustive set of symbol permutations derived from the plurality of sets of representative symbols wherein each symbol permutation is a unique representation of the refined token list and wherein each symbol permutation comprising one representative symbol for each token in the refined token list;
generating for each of the symbol permutations a plurality of sets of representatives concepts, wherein each symbol in each symbol permutation has a corresponding set of representative concepts and wherein the concepts are contextually relevant to the common subject;
generating for each of the symbol permutations an exhaustive set of concept permutations derived from a corresponding plurality of sets of representative concepts wherein each concept permutation is a unique representation of a corresponding symbol permutation and wherein each concept permutation comprising of one representative concept for each symbol in the corresponding symbol permutation; and
calculating a similarity score between every concept permutation and a plurality of need-want associations and indicating a match when the similarity score reaches a threshold.

11. The processor implemented method of claim 1o, wherein the selected contextually relevant symbols and concepts are extracted from a knowledge base comprising a plurality of symbols and concepts relevant to a plurality of subjects.

12. An apparatus for converting user idea inputs into matching idea triggers, comprising:
a memory; and
a processor disposed in communication with said memory, and configured to issue a plurality of processing instructions stored in the memory, wherein the processor issues instructions to:
receive a user idea input request including at least a user-specified subject, a user-specified need to be satisfied and a user-specified wanted solution to satisfied said need;
determine a class to which the user-specified subject belongs and adding a node that is semantically equivalent to the user-specified subject to a directed acyclical graph under a graph section corresponding to the determined class only after verifying that there is no node under the corresponding class that is semantically equivalent to the user-specified subject residing in the graph already;
concatenate the user-specified need and the user-specified wanted solution to generate a need-want structure; and
determine a corresponding match to the generated need-want structure from a set of need want associations linked to the semantically equivalent node or linked to any node in a sequence that contains all the semantically equivalent node ancestors, starting with its immediate parent and ending with the root node and increasing a demand score associated with the need want structure if a corresponding match is found.

13. The apparatus of claim 12, further comprising processing instructions to:
send a need want corroboration request to an idea receiver server associated with the semantically equivalent node if a corresponding match is not found;
adapt the need-want structure to conform to the format of a need-want association and link it to the semantically equivalent node only after receiving a positive need want corroboration response form the idea receiver server;
calculate a user insightfulness score; and
send a message directed to the user who submitted the user idea input request comprising information about the submitted idea, information from the idea receiver and an insightfulness score.

14. The apparatus of claim 12, further comprising processing instructions to:
send a message directed to the user who submitted the user idea input request comprising information about the submitted idea.

15. The apparatus of claim 13, further comprising processing instructions to:
receive by the idea receiver server a new need want association review response;
categorize a user-defined need want structure;
generate a message directed to the user who submitted the user idea input request;
store the need want structure as a need want association in a local repository; and
send a need want corroboration response comprising the generated message.

16. The apparatus of claim of claim 15, wherein said categorization value of the user-defined need want structure is selected from the group comprising of spam, not an idea, duplicate type, more info request type, not feasible type, not strategic type, already live type, and new valid.

17. The apparatus of claim 13, further comprising processing instructions to:
send periodic notifications to the user who submitted the user idea input request comprising idea statuses communicating at what stage the inputted idea is in an implementation process and current user insightfulness score;

18. The apparatus of claim 16, further comprising processing instructions to:
record data related to a new subject added to the directed acyclic graph wherein said subject data is selected from the group of data comprising of type, revenue, profit, locations, number of employees, geographic markets, headquarter location, customer type, founded date, and default thinker role; and
record data related to the user who has submitted the idea input request said user data is selected from the group of data comprising of date of birth, sex, gender, socioeconomic status, highest education level, nationality, country of residency, family members, and marital status.

19. The apparatus of claim 18, further comprising processing instructions to:
feed a plurality of recorded data into an inference engine comprising at least one system generated dimension;
generate at least one insight with respect to at least one of the said comprising dimensions; and
save at least one insight into a knowledge base associated to at least one of the said comprising dimensions.

20. The apparatus of claim 19, further comprising processing instructions to:
receive a user request for at least one insight comprising at least one dimension; and
retrieve from a knowledge base at least one insight, related to at least one received dimension wherein the retrieved data comprises integrated data for upstream marketing.
